(19) United States
(12) Patent Application Publication
(10) Pub. No.: US 2010/0226016 A1
(43) Pub. Date: Sep. 9, 2010

(54) LIGHT-SHIELDING FILM

(75) Inventors: Tatsushi Hirauchi, Takatsuki-shi (JP); Ai Matsumoto, Takatsuki-shi (JP); Nobuyuki Ando, Tenri-shi (JP); Junichi Nakamura, Suita-shi (JP)

Correspondence Address: CONNOLLY BOVE LODGE & HUTZ LLP, 1875 EYE STREET, N.W., SUITE 1100, WASHINGTON, DC, 20006, US

(73) Assignee: Nippon Shokubai Co., Ltd., Osaka-shi (JP)

(21) Appl. No.: 12/670,322

(22) PCT Filed: Jul. 25, 2008
(86) PCT No.: PCT/JP2008/063812

§ 371 Date: Mar. 18, 2010

(30) Foreign Application Priority Data
Jul. 25, 2007 (JP) 2007-193561

(51) Int. Cl. G02B 1/04; B05D 5/06; B29C 59/02

(52) U.S. Cl. 359/614; 427/162; 264/293

(57) ABSTRACT

The present invention relates to a light-shielding film excellent in light-shielding property and heat resistance, a production method of such a film, and a lens unit including such a film. The present invention is a light-shielding film including an organic resin and a black material, wherein the organic resin is a cured product of a curable resin or a thermoplastic resin having a glass transition temperature of 150 degrees C. or more. The present invention is also a production method of a light-shielding film comprising an organic resin and a black material, wherein the production method includes a surface roughness-forming step of forming a rough surface of the light-shielding film by a transfer method. Further, the present invention is a lens unit including the light-shielding film and a lens, wherein the lens unit has reflow resistance.

### TECHNICAL FIELD

The present invention relates to a light-shielding film and a lens unit including the light-shielding film. More specifically, the present invention relates to a light-shielding film mounted on a lens unit, which can be used in an optical application, an opto device application, or a display device application, or used as a mechanical component, an electrical and electronic component, and the like. The present invention further relates to a lens unit including such a film.

### BACKGROUND ART

A light-shielding film is useful as a mechanical component, an electrical and electronic component, an automobile component, and the like. Such a light-shielding film is mounted on a lens unit particularly preferably used as an optical member, and the like. For example, in a camera module such as a digital camera and a camera for mobile phones, a light-shielding film is used to suppress generation and spread of optical noise inside a lens unit. The following film has been currently used as such a light-shielding film: carbon black is mixed with polyethylene terephthalate (PET) to form a black film, and then the black film is provided with a light-shielding property by forming roughness on the film surface.

Optical members and the like have been recently downsized. For example, a digital camera module is mounted on a cellular phone. Therefore, a reduction in size, thickness, and weight of the optical members has been increasingly desired. Along with this, a reduction in size, thickness, and weight is needed for a light-shielding film used in a digital camera module and the like, or for a lens unit having a lens and the like. Further, for the light-shielding film or the lens unit, a reduction in costs is also needed in addition to the reduction in size, thickness, and weight. Therefore, a resin lens has been increasingly used instead of the glass lens. Further, a plastic lens such as PMMA, PC, and polycycloolefin instead of inorganic glass has been increasingly adopted. In such a technical field of the plastic lens, if a reflowable plastic lens having excellent heat resistance is prepared in order to further reduce the costs and along with this, various members have more improved heat resistance, a resin lens is expected to be increasingly used instead of the glass lens. Such a light-shielding film and the like have not been formed of a reflowable material, yet.

Japanese Patent No. 3731033 on pages 1 and 2 discloses the following light-shielding film as a light-shielding film excellent in heat resistance and a polyimide resin as a base material of the light-shielding film. The light-shielding film includes a light-shielding layer containing black fine particles and silicone resin or a fluorine-containing resin with an average particle diameter of 0.5 to 20 μm. The light-shielding layer is prepared on at least one surface of a base material film such as a PET using a binder resin having a glass transition temperature (Tg) of 40° C. or more. However, even such a film has room for improvement in heat resistance, light-shielding property for optical noise, and price when such a film is used in a camera module having reflow resistance (specifically, reflowable camera module). That is, a film satisfying the followings has been needed: to have a Tg of 40 to 150° C. as a heating resistance of a binder resin and further improve the heat resistance; to improve the light-shielding property for optical noise although the film includes synthetic resin particles excellent in heat resistance and therefore it is insufficient in blackness; and to improve the cost performance because the film includes synthetic resin particles of an expensive silicone resin or fluorine-containing resin.

The following production methods were disclosed as a method for producing a light-shielding film. Japanese Kokai Publication No. Hei-01-12503 on pages 1 and 2 discloses, as a method of providing a film surface with roughness, a method of subjecting a polyester film containing carbon black into a sandblasting treatment. Japanese Kokai Publication No. 2003-147275 on pages 1 to 3 discloses a method of forming roughness attributed to fine particles on a surface of a black base material film by bonding an organic filler (matte agent) to the black film surface using a binder resin. Japanese Kokai Publication No. 2003-266580 on pages 1 to 3 discloses a method of forming roughness attributed to fine particles by bonding an organic filer and black fine particles to a surface of a transparent base material film using a binder resin. However, these technologies on the production method of the light-shielding film are insufficient in order to improve the functions and added values on which development has been currently advanced in the optical field. There is still room for improvement in order to produce a light-shielding film which has excellent light-shielding property and reflow resistance and which permits a higher value-added optical apparatuses, for example, a downsized lens unit.

### DISCLOSURE OF THE INVENTION

### Problem to be Solved by the Invention

The present invention has been made in view of the above-mentioned state of the art. The present invention provides a light-shielding film excellent in light-shielding property and heat resistance, a production method of such a film, and a lens unit including such a film.

### Means for Solving the Problem

The present inventors made various investigations on a light-shielding film. The inventors noted that the currently used resin is a thermoplastic resin having a low glass transition temperature such as polyethylene terephthalate. Then, the inventors found that if a thermoplastic or curable resin having a high glass transition temperature is used as a raw material for the light-shielding film, the produced light-shielding film can be applied to a reflowable camera module, and that such a light-shielding film is an inexpensive film which can be automatically mounted. Further, the inventor also found that if a specific organic resin is used, a black material (for example, black fine particles) can be uniformly dispersed or dissolved, as a dispersion matrix, in an organic resin, and thereby a black light-shielding film having sufficiently excellent light-shielding property can be produced. Further, the inventors found the followings. A thermoplastic resin having high heat resistance is insufficient in solvent solubility. Therefore, a black material is melted and kneaded, thereby being dispersed into such a thermoplastic resin, generally. In this method, it is difficult that the black material is uniformly dispersed. In contrast, in the present invention, the black material is uniformly dispersed, as a matrix dispersion, into a resin having high heat resistance. That is, the inventors found that a light-shielding film (heat-resistant light-shielding film) which has heat resistance needed particularly in production processes of a reflowable camera module and which has excellent light-shielding characteristics can be obtained. As a result, the above-mentioned problems have been admirably solved. Further, the inventors found that the light-shielding film exhibits more excellent light-shielding property if the surface of the light-shielding film is provided with roughness and thereby reflective light generated if the film has a smooth surface is suppressed. In addition, the inventors found a method of easily providing the light-shielding film surface with the roughness, and according to such a method, a film having an excellent light-shielding property can be inexpensively and continuously produced. Further, the inventors found that such a film can be preferably used in an optical application, an opto device application, a display device application, or used as a mechanical component, an electrical and electronic component, and the like, and that such a light-shielding film functions as a light-shielding member in an optical device such as a camera, thereby suppressing generation and spread of optical noise inside the lens unit. As a result, the present invention has been completed.

That is, the present invention is a light-shielding film including an organic resin and a black material, wherein the organic resin is a cured product of a curable resin or a thermoplastic resin having a glass transition temperature (hereinafter, also referred to as a “Tg”) of 150° C. or more.

The present invention is also a light-shielding film including an organic resin and a black material, wherein the organic resin is at least one selected from the group consisting of a polyimide resin, an epoxy resin, a fluorinated aromatic polymer, a polyether ketone resin, and a polyethylene naphthalate resin.

The present invention is a production method of a light-shielding film including an organic resin and a black material, wherein the production method includes a surface roughness-forming step of forming a rough surface of the light-shielding film.

Further, the present invention is a lens unit including the light-shielding film and a lens, wherein the lens unit has reflow resistance.

The present invention is mentioned below in more detail.

The present invention is a light-shielding film including an organic resin and a black material. Such a light-shielding film (also referred to as a “light-shielding film”) has a function of shielding light having a desired wavelength, for example, by scattering or absorbing such light. If such a light-shielding film is mounted on a lens unit, for example, the light-shielding film has a function of shielding light in a visible light region, a UV region, or an IR region, which a photoelectric conversion sensor receives. Further, the light-shielding film suppresses generation and spread of optical noise inside the lens unit and eliminates the generated optical noise.

The above-mentioned organic resin included in the light-shielding film contains a cured product of a curable resin or a thermoplastic resin having a Tg of 150° C. or more. The use of the organic resin makes it possible to inexpensively produce a light-shielding film excellent in heat resistance. Further, due to the use of the organic resin, such a light-shielding film obtains reflow resistance. An organic resin which is excellent in compatibility with the black material that is to be contained in the light-shielding film and into which the black material is uniformly dispersed is preferable as such an organic resin. The light-shielding film of the present invention may include other components as long as it includes the organic resin and the black material. A composition containing an organic resin raw material before curing or shaping and, if necessary, other components, is also referred to as a resin composition. A composition containing the resin composition and the black material is also referred to as a light-shielding resin composition. The organic resin raw material may be a curable resin that is a raw material for the cured product or may be a thermoplastic resin, for example. In the present description, the “cured product of a curable resin” means a cured or semi-cured product of a curable resin. A cured product having a cross-linking structure formed by cross-linking of a curable resin may be mentioned as a preferable embodiment.

The above-mentioned organic resin raw material in the light-shielding resin composition may be the same as the organic resin constituting the light-shielding film or a precursor or monomer of the organic resin.

The above-mentioned organic resin constituting the light-shielding film is a thermoplastic resin having a Tg of 150° C. or more, the organic resin raw material is (1) the same as the organic resin, or (2) a precursor or monomer of the organic resin, for example. Polyether ether ketone (PEEK) and the like may be mentioned as the organic resin raw material (1). Further, if the organic resin is polyimide, a polyamic acid, a diamine compound (preferably, an aromatic diamine compound) that is a raw material for the polyamic acid, a tetracarboxylic dianhydride (preferably, aromatic tetracarboxylic dianhydride), and the like may be mentioned as the organic resin raw material (2).

If the above-mentioned organic resin constituting the light-shielding film is a cured product of a curable resin, the organic resin raw material is different from the organic resin, and it is a precursor or monomer of the organic resin. For example, if the organic resin raw material is an epoxy resin that is a curable resin, the following embodiments may be mentioned. If the above-mentioned organic resin constituting the light-shielding film is a cationically curable epoxy resin, a polyfunctional epoxy compound may be mentioned as the organic resin raw material. If the light-shielding resin composition contains a curing agent such as an acid anhydride, a polyamine, and a polyphenol, in addition to the organic resin raw material such as a polyfunctional epoxy compound, these curing agents are also organic resin raw materials. An embodiment in which the light-shielding resin composition contains a cationically curing catalyst is also mentioned as a preferable embodiment of the resin composition.

Examples of the above-mentioned curable resin include a resin cured by UV irradiation (UV-curable resin), a resin cured by heat (heat-curable resin), a resin cured by electron beam (electron beam-curable resin), and a resin cured by light (photo-curable resin). The molecular weight of the curable resin before curing is not especially limited. A resin having a high molecular weight or a molecular weight equivalent to that of an oligomer can be used. The embodiment of the organic resin raw material containing the curable resin include embodiments: (1) the organic resin raw material is a liquid or solid curable resin; (2) the organic resin raw material contains a liquid or solid curable resin and a curable compound having a molecular weight lower than that of the curable resin or a (noncurable) solvent, and the like; and (3) the organic resin raw material contains a liquid or solid noncurable resin and a curable compound having a molecular weight lower than that of the noncurable resin. An embodiment in which the organic resin raw material contains an oligomer component of an acrylic resin such as PMMA and (meth)acrylate monomer, and the like, may be mentioned as the above-mentioned embodiment (3) in which the organic resin raw material contains a liquid or solid noncurable resin and a curable compound having a molecular weight lower than that of the noncurable resin.

Preferable examples of the above-mentioned curable resin include a compound containing at least one epoxy group, a polyphenol compound, and a compound having a polymerizable unsaturated bond. These compounds can be used singly or as a mixture of two or more species of them. Among these, the compound containing at least one epoxy group is preferable. The compound containing at least one epoxy group can show heat resistance equivalent to that of inorganic glass and can exhibit excellent characteristics such as excellent formability and processability. Examples of the compound containing at least one epoxy group, the polyphenol compound, and the compound having a polymerizable unsaturated bond, which can be preferably used as the curable resin of the present invention, are mentioned below.

The above-mentioned epoxy group is an organic group having an oxirane ring. The organic group containing an oxirane ring such as a glycidyl group includes an epoxy group. Therefore, the compound containing an epoxy group includes a compound containing a glycidyl group. An embodiment in which the compound containing at least one epoxy group is a compound containing at least one glycidyl group is also one of the preferable embodiments. Further, the compound may contain a plurality of epoxy groups. With the glycidyl group, an epoxy group different from the epoxy group contained in the glycidyl group may be coexist in the compound.

Further, an epoxy resin raw material, a polyimide resin raw material, and the like may be preferably used as the curable resin. The epoxy resin is preferable because it is a heat-resistant resin having a high Tg and it has low wavelength dependence of optical characteristics, particularly a transmittance. The polyimide resin is preferable because it is a heat-resistance resin having a Tg of 150° C. or more. The Tg of the cured product of the curable resin such as the epoxy resin and the polyimide resin means a Tg of a cured product after curing. The Tg of the cured product prepared by curing the above-mentioned curable resin is not especially limited, but preferably 100° C. or more in terms of heat resistance. The Tg is more preferably 120° C. or more and still more preferably 150° C. or more.

With regard to the polyimide resin, two embodiments: the polyimide resin is a cured product of a curable resin; and the polyimide resin is a thermoplastic resin, are mentioned. The polyimide resin can be appropriately used as a curable resin or a thermoplastic resin. The polyimide resin is mentioned below. A polyimide resin which is melted and a polyimide resin which is not melted even by heating at 400° C. or less are mentioned as a polyimide resin preferably used as the organic resin constituting the light-shielding film. In this description, the former polyimide resin (not melted even by heating at 400° C. or less) is referred to as a cured product of a curable resin and the latter polyimide resin (melted by heating at 400° C. or less) is referred to as a thermoplastic resin. When the polyimide resin is explained, the curable resin or the raw material for the cured product of a curable resin means a raw material for the former polyimide resin (not melted by heating at 400° C. or less), and the raw material for the thermoplastic resin means a raw material for the latter thermoplastic polyimide resin.

In the present description, the “heat-resistant resin” means a thermoplastic resin and/or a cured product of a curable resin. The heat-resistant resin preferably has a high Tg, and more preferably has a Tg of 100° C. or more, a Tg of 120° C. or more, and a Tg of 150° C. or more.

Preferable examples of the above-mentioned thermoplastic resin having a Tg of 150° C. or more include a fluorinated aromatic polymer, a polyether ketone resin, a polyethylene naphthalate resin, a polyimde resin. In the present description, a fluorinated aromatic polyether ketone resin is not included in the “fluorinated aromatic polymer.”

A fluorinated aromatic polymer, a polyimide resin, a polyether ketone resin, and a polyethylene naphthalate resin are preferably used as the above-mentioned thermoplastic resin having a Tg of 150° C. or more because they have a high Tg and they can be preferably used in a reflowable process. A fluorinated aromatic polymer, a polyimide resin, and a polyether ketone resin are more preferable. A polyether ketone resin and a polyimide resin are still more preferable.

An aromatic ring-containing aromatic polyether ketone resin, and a partly or completely fluorinated polyether ketone resin are preferable as the above-mentioned polyether ketone resin. A fluorinated polyether ketone resin is more preferable and a fluorinated aromatic polyether ketone resin in which an aromatic ring is partly or completely fluorinated is still more preferable. If the fluorinated aromatic polyether ketone resin that is a solvent-soluble raw material is used, alight-shielding film having excellent heat resistance can be obtained.

The above-mentioned fluorinated aromatic polyether ketone resin preferably is a polymer having at least one of the following constitutional units:

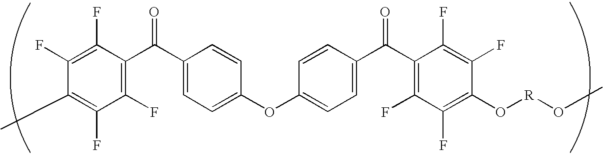

in the formula, R representing at least one group represented by the following formula:

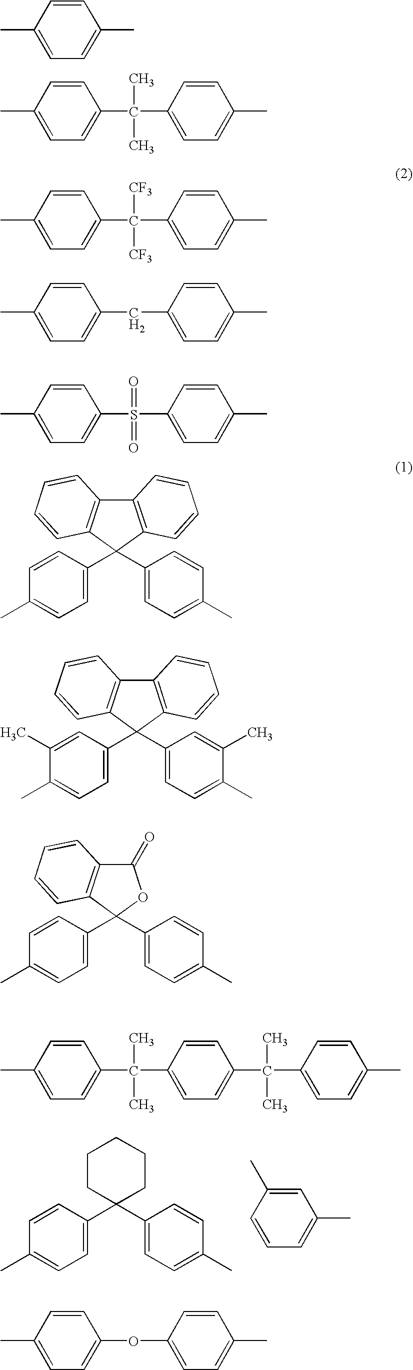

A polymer having at least one of the above-mentioned constitutional units as a repeating unit is more preferable. A polymer having a constitutional unit (I) containing the above-mentioned group (1) as a repeating unit and a polymer having a constitutional unit (II) containing the above-mentioned group (2) as a repeating unit are still more preferable.

With respect to the molecular weight of the above-mentioned fluorinated polyether ketone resin, the fluorinated polyether ketone resin preferably has a number average molecular weight of 10000 to 200000, and more preferably 20000 to 150000, and still more preferably 30000 to 120000.

The above-mentioned number average molecular weight is measured by GPC (gel permeation chromatography) on a styrene equivalent basis. The measurement by GPC is performed under the following conditions.

Model: product of TOSOH CORP., HLC-8120GPC

### Column: G-5000HXL+GMHXL-L

Developing solvent: THF
Flow rate: 1 ml/min
Standard: Standard polystyrene is used

One or more different resins selected from the polyimide resin, the epoxy resin, the fluorinated aromatic polymer, the polyether ketone resin, the polyethylene naphthalate resin can be preferably used as the above-mentioned organic resin, as mentioned above. Thus, the present invention includes a light-shielding film including an organic resin and black fine particles, wherein the organic resin is at least one selected from the group consisting of a polyimide resin, an epoxy resin, a fluorinated aromatic polymer, a polyether ketone resin, and a polyethylene naphthalate resin.

The above-mentioned thermoplastic resin has a Tg of 150° C. or more. The thermoplastic resin having a Tg of 150° C. or more is excellent in both heat resistance and flexibility. If the thermoplastic resin has a Tg of less than 150° C., the resin has heat resistance insufficient for a reflowable process and hence might not be preferably used in various applications. The Tg is more preferably 180° C. or more, still more preferably 190° C. or more, and particularly preferably 200° C. or more, and most preferably 230° C. or more. For example, if the light-shielding film is mounted on a lens module, the lens module is exposed to a high temperature in a element-forming step and the like. In such a case, the film is suppressed from being deformed at a temperature where the element-forming step is performed if the film has a high Tg within the above-mentioned range. Further, if a lens unit including the light-shielding film of the present invention has reflow resistance, the lens unit can be automatically mounted in a soldering reflow step. As a result, the production costs can be more reduced. It is preferable that the light-shielding film has a Tg of 230° C. or more in order to have heat resistance high enough for the soldering reflow step. That is, the preferable embodiments of the present invention include an embodiment in which the light-shielding film of the present invention is used in a lens unit that can be subjected to a soldering reflow process.

The above-mentioned thermoplastic resin has a number average molecular weight of 10000 to 200000 and preferably 20000 to 150000. The number average molecular weight is still more preferably 30000 to 120000. If the thermoplastic resin has a number average molecular weight of 10000 or less, such a resin might not excellent in heat resistance. If it has a number average molecular weight of 200000 or more, a polymer might be gelled.

It is preferable that the above-mentioned light-shielding film has a glossiness of 20 or less. If the light-shielding film has a glossiness of more than 20, the film might not sufficiently shield light. Therefore, if such a film is used in a lens unit, for example, noise is generated, resulting in defects. The glossiness is more preferably 10 or less and still more preferably 5 or less. The above-mentioned glossiness was measured at a measurement angle (θ) of 60° using VG-2000, product of NIPPON DENSHOKU INDUSTRIES CO., LTD.

The light-shielding film of the present invention includes the black material. The above-mentioned black material provides the light-shielding film of the present invention with a light-shielding property. Various black materials can be used. The content of the black material in the above-mentioned light-shielding film is preferably 1 to 50% by weight relative to 100% by weight of a total amount of the black material and the organic resin. If it is less than 1% by weight, the film might have an insufficient light-shielding property. If it is more than 50% by weight, a composition for forming a light-shielding layer (light-shielding resin composition) is hard to handle because of its too high viscosity. Further, a film prepared using such a composition might be broken. The content is more preferably 3 to 40% by weight and still more preferably 5 to 30% by weight. It is preferable that the black material is dispersed or dissolved in the organic resin. If the black material is not dispersed or dissolved in the organic resin, the light-shielding film might not be uniformly blackened, possibly resulting in insufficient light-shielding property. That is, it is preferable that the light-shielding film of the present invention is obtained using, as a raw material, a light-shielding resin composition prepared by dispersing or dissolving a black material in the organic resin raw material (resin binder).

The following materials may be preferably used as the above-mentioned black material. The following black fine particles. Carbon fine particles such as carbon black and graphite; inorganic black fine particles, e.g., metal oxide black fine particles such as titanium black; black organic fine particles (organic black fine particles) such as aniline black. Anthraquinone, indigoid, diazo black organic dyes. In addition to the above-mentioned titanium black, preferable examples of the above-mentioned inorganic black fine particles (inorganic black materials) include: magnetite; copper (I) oxide (cuprous oxide); a composite oxide black fine particle containing copper and chromium as a main metal component; a composite oxide black fine particle containing copper and manganese as a main metal component; a composite oxide black fine particle containing copper, iron, and manganese as a main metal component; and a composite oxide black fine particle containing cobalt, chromium, and iron as a main metal component.

Among the above-mentioned black material, fine particles are preferable as the black material. Various black fine particles can be used. Among these black fine particles, the carbon fine particles and the inorganic black fine particle are preferable in terms of excellent heat resistance. A carbon material such as the carbon fine particles is preferable in terms of excellent light-shielding performances in a visible light region. Carbon black is more preferable because it is an ultrafine particle and excellent in dispersibility in the organic resin, and therefore it can uniformly blacken the light-shielding film. The carbon black is also preferable because of its strong black color and inexpensiveness, in addition to excellent heat resistance.

It is preferable that the black fine particles have a primary particle size of 1 μm or less. The primary particle size is more preferably 0.1 μm or less. Further, it is preferable that the black fine particles are hardly secondarily-aggregated. Further, if the black fine particles are dispersed into the organic resin, it is preferable that the black fine particles are dispersed to have a particle size of 1 μm or less. The particle size of the black fine particles dispersed into the organic resin is more preferably 0.5 μm or less and still more preferably 0.1 μm or less. In the case where the black fine particles are dispersed into the organic resin, the smaller particle size the black fine particle has, the more uniform hue (black) the resin composition has. If the black fine particles having a particle size of 1 μm or less are dispersed, no defects attributed to a coarse particle of the black fine particles are generated. Therefore, such a light-shielding film is excellent in processability when the light-shielding film surface is provided with roughness.

A dibutyl phthalate absorption amount can be employed as an index of dispersibility if the above-mentioned black fine particle is carbon black. The oil absorption amount is preferably 300 ml/100 g or less. Thus, the preferable embodiments of the present invention include the light-shielding film, wherein the black fine particles include carbon black having an absorption amount of 300 ml/100 g or less. If the oil absorption amount is more than 300 ml/100 g, the dispersibility of the carbon black is reduced and therefore the light-shielding film might have insufficiently uniform hue (black). Further, the coarse particle of the carbon black is formed and therefore the film might exhibit insufficient processability when the film surface is provided with the roughness. The above-mentioned oil absorption amount is more preferably 250 ml/100 g or less and still more preferably 200 ml/100 g or less. The above-mentioned oil absorption amount shows characteristics of carbon black itself (carbon black in a powder state) and shows characteristics of carbon black before being dispersed into the organic resin and the like. The aggregated carbon black shows a high oil absorption amount and the dispersed carbon black shows a low oil absorption amount. When carbon black is more dispersed, the film has more uniformed hue. Therefore, it is preferable that the oil absorption amount is smaller. Thus, the light-shielding film preferably has an embodiment in which the black fine particles are dispersed. That is, it is preferable that the light-shielding film of the present invention is obtained using, as a raw material, the light-shielding resin composition containing the black fine particles dispersed into the organic resin raw material (resin binder). An embodiment in which the light-shielding film contains the black material is not especially limited. For example, an embodiment in which the below-mentioned black material and the like is contained in the light-shielding film (light-shielding layer) or in the light-shielding resin composition as particles (black material-containing particles) in which the above-mentioned black material is dispersed into or is in complex with another component such as a resin is also included in the light-shielding film (light-shielding layer) and the light-shielding resin composition in the present invention. A preferable resin constituting the black material-containing particle is not especially limited. The resins which are mentioned above as a preferable organic resin constituting the light-shielding film may be mentioned. Further, as a specific embodiment, it is preferable that the black material-containing particle contains as the resin component, the same kind of resin as the organic resin included in the light-shielding film or an organic resin having a refractive index equivalent to that of the organic resin included in the light-shielding film.

The method of producing the above-mentioned light-shielding resin composition, that is, a way (method) of dispersing or dissolving the black material (preferably, black fine particles) into the resin binder (organic resin raw material) is not especially limited. Various methods may be preferably used. If the resin binder has solvent solubility, for example, the following various methods are appropriately selected and employed depending on the black fine particles and the organic resin. A method of mixing and dispersing or dissolving the black material into a resin binder solution prepared by dissolving the organic resin raw material into a solvent; a method of dissolving the resin binder into a black material-dispersed liquid; a method of mixing and dispersing or dissolving the black material into a dispersion in which the resin binder is dispersed to be fine particles; and a method of melting and kneading a mixture of the resin binder with the black fine particles. Among these, the method of mixing and dispersing or dissolving the black material in a resin binder solution prepared by dissolving a solvent-soluble organic resin raw material in a solvent is preferable. If the solvent-soluble organic resin raw material is used, it is easy to uniformly disperse or dissolve the black material into a mixture including the organic resin raw material and the solvent (for example, a solution of an organic resin raw material). Therefore, a light-shielding resin composition including uniformly dispersed or dissolved black material is obtained, and as a result, an excellent light-shielding film including uniformly dispersed black materials can be obtained. Thus, a light-shielding film including the organic resin prepared using a solvent-soluble organic resin raw material is one of the preferable embodiments of the present invention.

The above-mentioned solvent is appropriately selected depending on the kind of the resin. Examples of the solvent include: ketones such as methyl ethyl ketone (2-butanone), methyl isobutyl ketone (4-methyl-2-pentanone), and cyclohexanone; glycol derivatives (ether compound, ester compound, ether ester compound, and the like) such as PGMEA (2-acetoxy-1-methoxypropane), ethylene glycol mono-n-butyl ether, ethylene glycolmonoethyl ether, and ethylene glycol ethyl ether acetate; and amides such as N,N-dimethylacetamide; esters such as ethyl acetate, propyl acetate, and butyl acetate; pyrrolidones such as N-methyl-pyrrolidone (specifically, e.g., 1-methyl-2-pyrrolidone); aromatic hydrocarbons such as toluene and xylene; aliphatic hydrocarbons such as cyclohexane and heptane; and ethers such as diethyl ether and dibutyl ether.

More preferable examples of the above-mentioned solvents include methyl ethyl ketone (2-butanone), methyl isobutyl ketone (4-methyl-2-pentanone), cyclohexanone, PGMEA (2-acetoxy-1-methoxypropane) N,N-dimethylacetamide, ethyl acetate, and 1-methyl-2-pyrrolidone (NMP). These solvents are preferable particularly if the above-mentioned organic resin raw material is the same as the organic resin (for example, the organic resin is a thermoplastic resin).

Further, N-methyl-pyrrolidone, N,N′-dimethylacetoamide, aromatic hydrocarbons, and mixtures thereof are more preferable if the above-mentioned organic resin raw material is polyamic acid that is a raw material for polyimide resin, or an aromatic diamine compound and an aromatic tetracarboxylic dianhydride which are raw materials for polyamic acid. Ketones, aromatic hydrocarbons, glycol derivatives, or mixtures thereof are more preferable if the above-mentioned organic resin raw material is a polyfunctional epoxy compound that is a raw material for epoxy resin, or a polyfunctional epoxy compound and a curing agent.

Among the above-mentioned organic resin raw materials, preferable examples of the above-mentioned solvent-soluble organic resin raw material include: solvent-soluble curable resins that are raw materials for various epoxy resins, such as epoxy compounds; and solvent-soluble thermoplastic resins such as solvent-soluble polyether ketone resins and solvent-soluble polyimide resins. In addition, among these organic resin raw materials, if the organic resin material is a solvent-soluble curable resin that is a raw material for various epoxy resins such as an epoxy compound, an organic resin constituting the light-shielding film of the present invention is compositionally different from the organic resin raw material. If the organic resin raw material is a solvent-soluble thermoplastic resin, an organic resin constituting the light-shielding film is compositionally the same as or different from the organic resin raw material. In the present description, “the organic resin is the same as the organic resin raw material” means that the organic resin and the organic resin raw material are compositionally the same, and “the organic resin is different from the organic resin raw material” means that the organic resin is compositionally different from the organic resin raw material.

If the organic resin raw material is the same as the organic resin constituting the light-shielding film, solvent-soluble polyether ketone resins and solvent-soluble polyimide resins are more preferable in terms of heat resistance, optical characteristics, solvent solubility and the like. Polyether ketone resins and polyimide resins and raw materials for these resins are still more preferable because carbon black shows excellent dispersibility in such resins. A fluorinated polyether ketone resin is preferable as the polyether ketone resins, as mentioned above. A fluorinated aromatic polyether ketone resin is more preferable. If the fluorinated aromatic polyether ketone resin is used, carbon black shows excellent dispersibility in such a resin.

It is preferable that the above-mentioned organic resin raw material is polyamic acid or an epoxy compound. An oligomer or a polymer obtained by reacting (condensing) aromatic diamine with aromatic tetracarboxylic acid dianhydride is preferable as the polyamic acid. A solution prepared by dissolving polyamic acid in a solvent such as N-methyl-pyrrolidone is commercially available as a polyimide varnish. This varnish is applied and then heated, thereby volatilizing the solvent. Further, the heating is continued or heating at a high temperature is performed, and thereby the varnish is imidated to become polyimide.

The above-mentioned solvent-soluble epoxy compound can be converted into a cured product (epoxy resin cured product), for example, by cationically curing a polyfunctional epoxy compound in the coexistence of a cationic curing catalyst or curing a polyfunctional epoxy compound using a curing agent such as an acid anhydride and polyamine. In any cases, a preferable embodiment is an embodiment in which the light-shielding film is obtained by applying, drying, and heating (polyimidating, curing) a light-shielding resin composition prepared by dispersing or dissolving the black material in a polyamic acid solution or an epoxy compound solution (cationic curing catalyst or curing agent).

The use amount of the above-mentioned solvent is preferably 150 parts by weight or more and 1900 parts by weight or less relative to 100 parts by weight of the organic resin raw material. The use amount thereof is more preferably 200 parts by weight or more and 1400 parts by weight or less.

The organic resin of the present invention includes the above-mentioned cured product of the curable resin or the thermoplastic resin having a Tg of 150° C. Such an organic resin may include a heat-resistant resin having a Tg of 150° C. or more (also referred to as a “resin A”) or a cured product of a curable resin having a Tg of less than 150° C. (also referred to as a “resin B”). Thus, the preferable embodiments of the present invention also include a light-shielding film including an organic resin and a black material wherein the organic resin includes a thermoplastic resin having a Tg of 150° C. or more and a cured product of a curable resin having a Tg of less than 150° C. A thermoplastic resin having a Tg of 150° C. or more and/or a cured product of a curable resin having a Tg of 150° C. or more are/is preferable as a preferable embodiment of the heat-resistant resin having a Tg of 150° C. or more.

The above-mentioned resin A may be either the thermoplastic resin having a high Tg of 150° C. or more or the cured product of the curable resin having a high Tg of 150° C. or more. The Tg of the resin A is 150° C. or more. The preferable range of the Tg, and the like are the same as in the thermoplastic resin having a Tg of 150° C. or more. Preferable examples of the heat-resistant resin having a Tg of 150° C. or more (resin A) include an epoxy resin, a fluorinated aromatic polymer, a polyether ketone resin, a polyethylene naphthalate resin, and a polyimide resin. Among these, an epoxy resin, a polyether ketone resin, a polyethylene naphthalate resin, and a polyimide resin are preferable because they are excellent in optical characteristics, particularly in colorlessness. A fluorinated polyether ketone resin is preferable as the polyether ketone resin. A polyimide resin and a polyether ketone resin are preferable because they are excellent in heat resistance, particularly in Tg.

The material for the above-mentioned resin B is not especially limited as long as the above-mentioned cured product of the curable resin has a Tg of less than 150° C. A resin excellent in flexibility as well as heating resistance can be obtained. An epoxy resin and an unsaturated polyester resin are preferable, for example, as the cured product of the curable resin having a Tg of less than 150° C. (resin B). An epoxy resin is more preferable.

The above-mentioned light-shielding film is excellent in heat resistance because of the above-mentioned configuration. The heat resistance of the light-shielding film can be evaluated based on a change in the film shape when the film is heated at a high temperature. With regard to the change in the film shape, it is preferable that a dimensional change (a change in dimensions in the length and width directions in the surface plane, and in the thickness direction) between before and after heating is smaller. It is preferable that the film is excellent in shape retentivity. If the light-shielding film is excellent in shape retentivity (heat resistance), specifically, a change in each dimension (dimensional change) of the film between before and after heating at 200° C. for 1 minute is 10% or less. The size of a sample which is measured for dimensional change may be appropriately selected. In this experiment, a sample in 40.0 mm in length×10.00 mm in width×35 to 80 μm in thickness was used. If the film shows a dimensional change of 10% or less, such a light-shielding film can sufficiently exhibit characteristics under commonly employed conditions in the above-mentioned applications. For example, the light-shielding film can suppress generation and spread of optical noise inside the lens unit. The dimensional change is more preferably 5% or less, and still more preferably 3% or less, and particularly preferably 1% or less.

The above-mentioned dimensional change can be measured under more severe conditions. The heating temperature is preferably 250° C. Further, the heating time is preferably 2 minutes, and more preferably 5 minutes, and still more preferably 10 minutes. A light-shielding film which shows a dimensional change within the above-mentioned range under such severe conditions is more preferable.

With regard to the dimensional change, it is more preferable that the film shows 10% or less of a change (dimensional change) in each dimension between before and after heating at 260° C. for 2 minutes. It is preferable that the measurement is performed under air atmosphere. That is, it is preferable that the light-shielding film shows 10% or less of a dimensional change in each of length, width, and thickness between before and after heating at 260° C. for 2 minutes under air atmosphere. When the light-shielding film shows a small (10% or less) dimensional change by heating at 260° C. for 2 minutes, such a film can sufficiently endure a soldering reflow step when the light-shielding film is used in a lens unit. In this case, the dimensional change is more preferably 5% or less, and still more preferably 3% or less, and particularly preferably 1% or less.

It is preferable that at least one surface of the light-shielding film has a rough structure. Such a film having a rough structure has a matte surface and can prevent light reflection and shield light. Thus, the rough structure which at least one surface of the light-shielding film has is effective for controlling the glossiness of the light-shielding film to 20 or less, and further within the above-mentioned more preferable glossiness range.

With regard to the above-mentioned rough structure of the light-shielding film, the film has a surface that is rough enough for incident light to be scattered without specular reflection. Further, it is preferable that the roughness on the surface is large enough for shielded light to be scattered. For example, if the light-shielding film is used in a lens unit, light in a visible light region, a UV region, and an IR region can be effectively scattered. In this case, it is preferable that the film line roughness Ra (arithmetical mean deviation, JIS 1994) is 0.3 μm or more. The Ra is more preferably 0.5 μm or more, and still more preferably 1.0 μm or more, and particularly preferably 2.0 μm or more.

It is preferable that the film maximum height Ry is 5 μm or more. The Ry is more preferably 10 μm or more, and still more preferably 15 μm or more, and particularly preferably 20 μm or more. It is preferable the ten point height of roughness Rz is 5 μm or more. The Rz is more preferably 10 μm or more, and still more preferably 15 μm or more, and most preferably 20 μm or more. It is preferable that the mean spacing S of local peaks is 10 μm or less. The S is more preferably 5 μm or less, and still more preferably 3 μm or less, and particularly preferably 2 μm or less, and most preferably 1 μm or less.

As shown in FIG. 1, the above-mentioned arithmetical mean deviation Ra is calculated as follows. A portion stretching over a reference length (1) in the direction in which the average line m extends is cut out from the roughness profile f. This portion is presented in a graph with the X axis extending in the same direction as the average line m and the Y axis in the direction perpendicular to the X axis. Ra is calculated from the following formula when the roughness profile f is represented by y=f(x). This calculated Ra is expressed as micrometer (μm).

$${R}_{a} = \frac{1}{l} {\int }_{0}^{l} \vert f ( x ) \vert d x$$

In the formula, l represents the reference length. In FIG. 1, the region shown by the vertical lines shows a region surrounded by the roughness profile f and the average line m (the region surrounded by the roughness profile f, the average line m, and the line X=0 or 1, in the region where the line X=0 or 1 intersects with the roughness profile f). In FIG. 1, the region shown by the oblique lines has the same area as the total area in the region shown by the vertical lines. In this case, the region shown by the oblique lines is surrounded by the lines X=0, X=1, Y=Ra and Y=0.

The above-mentioned maximum height Ry is calculated as follows. As shown in FIG. 2, a portion stretching over a reference length (1) in the direction in which the average line m extends is cut out from the roughness profile f. In this portion, the gap between the peak line and the trough line is measured in the direction with which the roughness profile intersects. This measured value is expressed as micrometer (μm).

The above-mentioned ten point height of roughness Rz is calculated as follows. As shown in FIG. 3, a portion stretching over a reference length (1) in the direction in which the average line m extends is cut out from the roughness profile f. The average of the absolute values of the levels (Yp) of the highest peak to the fifth highest peak is measured in the direction perpendicular to the average line m in this portion. Further, the average of the absolute values of the levels (Yv) of the lowest through to the fifth lowest through similarly measured in this portion. Rz is a sum of these two averages, expressed as micrometer (μm).

That is, Rz is calculated from the following formula:

Rz=(|Yp1+Yp2+Yp3+Yp4+Yp5|+|Yv1+Yv2+Yv3+Yv4+Yv5|)/5

In the formula, Yp1+Yp2+Yp3+Yp4+Yp5 represents a sum of the levels of the highest peak to the fifth highest peak in the portion cut based on the reference length (1), and Yv1+Yv2+Yv3+Yv4+Yv5 represents a sum of the levels of the lowest through to the fifth lowest through in the portion cut based on the reference length (1).

The above-mentioned mean spacing (S) of local peaks is calculated as follows. As shown in FIG. 4, a portion stretching over a reference length (1) in the direction in which the average line m extends is cut out from the roughness profile f. In this portion, the length of the average line m between adjacent two peaks (referred to as spacing of local peaks) is measured. The arithmetic mean value of the spacing of local peaks is expressed as millimeter (mm). However, the spacing is too narrow and hence expressed as micrometer (μm) in this description. That is, the mean spacing (S) of local peaks is calculated from the following formula.

$$S = \frac{1}{n} {\sum }_{i = 1}^{n} {S}_{i}$$

In the formula, Si represents a spacing of local peaks and n represents the number of the spacing of local peaks within the reference length.

The above-mentioned rough structure is not especially limited as long as the surface has the above-mentioned rough structure. It is preferable that the light-shielding film has such a rough structure without containing fine particles other than the black fine particles. If the light-shielding film containing fine particles in addition to the black fine particles has a rough structure, white or light-colored fine particles are generally included as the fine particles. Therefore, external light is reflected by the fine particles existing near the surface of the light-shielding film and as a result, the light-shielding property of the light-shielding film might be insufficient. Particularly in order to produce a light-shielding film excellent in heat resistance, the used fine particles needs heat resistance. However, particles with high resistance such as spherical silica and silicone resin particles are white. The use of such white (or light-colored) fine particles inhibits the film to be blackened, and the film might not have an excellent light-shielding property. Therefore, addition of a great amount of black fine particles is needed, which is a disadvantage in that the roughness of the surface is uniformly formed on the surface. If the roughness is formed using the fine particles, particles having a uniform particle size distribution are needed for uniformly forming roughness, which results in increase in costs.

It is preferable that at least one surface of the light-shielding film has a rough structure. More preferably, both surfaces of the light-shielding film have a rough structure. If both surfaces of the light-shielding film have a rough structure, the above-mentioned effects can be sufficiently exhibited.

The light-shielding film of the present invention is not especially limited as long as it includes the light-shielding layer (also referred to as a black layer) including: the organic resin containing the cured product of the curable resin or the thermoplastic resin having a Tg of 150° C. or more. If necessary, the light-shielding film may contain other components. If the light-shielding layer is a thin film having an insufficient strength, it is preferable the light-shielding film includes a base material to have a sufficient strength. Preferable embodiments of the light-shielding film include: (1) an embodiment in which the light-shielding film is a multilayer film including a base material and the light-shielding layer (formed on one surface of the base material); (2) an embodiment in which the light-shielding film is a multilayer film including a base material and the light-shielding layers (each formed on both surfaces); and (3) an embodiment in which the light-shielding film is a single-layer film consisting of the light-shielding layer. FIG. 5 shows schematic views of these embodiments. FIG. 5(a) shows the embodiment (1). FIG. 5(b) shows the embodiment (2). FIGS. 5(c-1) and (c-2) show the embodiment (3). The light-shielding film of the present invention may appropriately include a layer having other functions.

According to the embodiments (1) and (2), the strength of the light-shielding film can be obtained because of the base material. Therefore, the light-shielding layer can be thinned. If the light-shielding layer is thin, the following advantages can be obtained: the film thickness can be easily controlled when the light-shielding resin composition is applied; the solvent contained in the composition can be vaporized and removed by drying for a short time; and a light-shielding layer in which generation of defects which reduce the light-shielding performances and which are generated in the film, such as foam generated when the solvent is vaporized, is suppressed, can be easily obtained.

According to the embodiments (1) and (2) in which the light-shielding film is a multilayer film including a base material and the light-shielding layer(s), the thickness of the light-shielding layer is preferably 5 μm or more, and more preferably 10 μm or more. The upper limit of the thickness of the light-shielding layer is preferably 80 μm or less, and more preferably 50 μm or less, and still more preferably 30 μm or less. Further, the particularly preferable range is 10 to 30 μm.

According to the embodiment in which the light-shielding layer (3) is a single layer (embodiment in which the light-shielding layer singly constitutes the light-shielding film), the light-shielding layer preferably has a thickness of 20 μm or more and more preferably has a thickness of 30 μm or more because of easy post-process of the film and excellent mechanical strength although depending on the organic resin of the light-shielding layer. The upper limit of the thickness of the light-shielding layer is preferably 200 μm or less and more preferably 100 μm or less in view of sufficient light-shielding performances and the application to a lens unit which highly needs to be thinned, although depending on the material for the light-shielding layer. The particularly preferable range of the thickness of the light-shielding layer is 30 to 80 μm.

The thickness of the above-mentioned light-shielding layer is preferably 1 to 1000 μm although depending on the embodiment of the light-shielding film and the application of the film, as mentioned below. The thickness of the above-mentioned light-shielding layer is more preferably 10 to 200 μm, and more preferably 20 to 100 μm. The thickness of the light-shielding layer is a thickness obtained by measuring the light-shielding layer for thickness using a micrometer. If the above-mentioned light-shielding layer has a thickness of 1 to 1000 μm, the light-shielding film of the present invention can be thinned. If the light-shielding film is used in an optical member, for example, the optical path can be shortened. As a result, this optical member (camera module, and the like) can be thinned.

If the above-mentioned light-shielding film contains a layer other than the light-shielding layer, it is preferable that a surface of the light-shielding layer, opposite to the surface on which the above-mentioned layer (the layer other than the light-shielding layer) is formed, has a rough structure. That is, it is preferable in the above-mentioned light-shielding film that at least one surface of the light-shielding layer has a rough structure. If the light-shielding layer has a rough structure, light reflection is suppressed and thereby the light-shielding film has sufficiently excellent light-shielding property. More specifically, the both surfaces of the light-shielding layer have a rough structure. If the light-shielding layer is not formed on the surface of the light-shielding film, it is preferable that both of the light-shielding layer and a layer formed on the light-shielding film have the rough structure.

Thus, the preferable embodiments of the present invention also include the light-shielding film, wherein the organic resin contains a cured product of a curable resin or a thermoplastic resin having a Tg of 150° C. (a heat-resistant resin having a Tg of 150° C. or a curable resin having a Tg of less than 150° C.), and the light-shielding film includes a light-shielding layer (black layer) prepared by dispersing or dissolving a black material in the organic resin raw material, and at least one surface of the light-shielding layer has roughness.

In the case where the light-shielding film includes the base material, the arrangement of the light-shielding layer and the base material in the above-mentioned light-shielding film is not especially limited because the operation and effects of the present invention are exhibited regardless of which of the two is arranged on a surface which light enters. However, an embodiment in which the light-shielding layer is arranged on the surface which light enters is preferable for preventing reflection.

The shape of the above-mentioned light-shielding film can be appropriately selected depending on the applications. If the light-shielding film is mounted on the lens unit, the light-shielding film is attached to an edge for fixing the lens. As a result, light can be effectively suppressed from being transmitted and reflected in a path other than the optical path, and thereby optical noise can be reduced. That is, in the lens unit, as schematically shown in FIG. 6, it is preferable that the light-shielding film (particularly, light-shielding layer) is attached to an edge for fixing the lens. That is, with regard to the positional relationship between the lens and the light-shielding film (particularly, light-shielding layer) in the lens unit, it is preferable that the lens and the light-shielding film (particularly, light-shielding layer) are arranged in such a way that the cross-section of the lens unit is shown by the schematic view in FIG. 7. Accordingly, it is preferable that the light-shielding layer of the light-shielding film has a planar shape (ring shape) as schematically shown in FIG. 8 when the lens unit is viewed from incident light direction. Nothing is formed in the center of the ring, or a transparent film which transmits visible light or a lens may be formed in the center of the ring. Preferably, nothing is formed in the center of the ring.

It is preferable that the light-shielding film has a single-layer structure. That is, an embodiment in which the light-shielding layer singly constitutes the light-shielding film is preferable. According to such an embodiment, the light-shielding film can be formed to have a small thickness. Therefore, if such a film is used in an optical application (lens unit), an optical path can be shortened and therefore the size and thickness of the lens unit can be reduced. FIG. 5(c) is a schematic view of the light-shielding film having a single-layer structure. FIG. 5(c-1) is an embodiment in which one surface has the rough structure. FIG. 5(c-2) is an embodiment in which the both surfaces have the rough surface.

If the light-shielding film of the present invention is produced by the below-mentioned method, a light-shielding film which has a single-layer structure and has at least one surface having the rough structure can be continuously produced. Further, a light-shielding film which is small (lightweight) and has high quality can be inexpensively produced.

It is preferable that the above-mentioned light-shielding film has a thickness of less than 1000 μm. The thickness is obtained by measuring the light-shielding film for thickness using a micrometer. The thickness of the above-mentioned light-shielding film is more preferably 200 to 10 μm and still more preferably 100 to 20 μm. If the above-mentioned light-shielding film has a thickness of less than 1000 μm, for example, an optical member including such a light-shielding film can be downsized because the optical path can be shortened.

If the light-shielding film of the present invention has the base material (as shown in FIGS. 5a and 5b), the light-shielding film has a sufficient strength. The material constituting the above-mentioned base material, any of organic materials, inorganic materials, organic-inorganic composite materials, and metal materials may be used. One or more species of them may be used. The above-mentioned organic materials (e.g., a thermoplastic resin composition and a curable resin composition) are preferable because of ease in handling. The inorganic materials (e.g., glass) are preferable because of excellent coefficient of thermal expansion. The organic-inorganic composite materials are preferable because of both of ease in handling and excellent coefficient of thermal expansion. Any of these materials can be preferably used. However, a material having reflow resistance is preferable.

A material having reflow resistance is preferable as the material for the above-mentioned base material constituting the light-shielding film. Specifically, it is preferable that the material includes at least one selected from the group consisting of (1) a fluorinated aromatic polymer, (2) a polycyclic aromatic polymer, (3) a polyimide resin, (4) a fluorine-containing polymer compound, (5) a glass film, and (6) a polyether ketone resin. Thus, the preferable embodiments of the present invention include the light-shielding film, wherein the light-shielding film is formed using at least one material selected from the group consisting of a fluorinated aromatic polymer, a polycyclic aromatic polymer, a polyimide resin, a fluorine-containing polymer compound, a glass film, and a polyether ketone resin.

Any of the above-mentioned materials can be preferably used as the above-mentioned base material. With regard to the above-mentioned materials for the base material, two or more species of them may be mixed or stacked. Among these, a base material having a multilayer structure consisting of two or more species of them can be preferably used because a plurality of characteristics attributed to the used materials is exhibited. For example, in a camera module application where the light-shielding film needs to be thinned to have a thickness of less than 100 μm, a problem in that an inorganic material such as glass is often broken by reducing the thickness (for example, 30 μm to 100 μm). Therefore, if the base material is a multilayer consisting of the organic material and/or the organic-inorganic composite material, deformation or crack of the base material is not caused when the light-shielding layer is stacked on the base material. Therefore, such a base material having a multilayer structure is preferably used in an optical member. More preferable is an embodiment in which the organic resin is formed on one or both surfaces of a glass thin film. Particularly preferable is an embodiment in which the organic resin is formed on both surface of the glass thin film. An organic substance may be stacked on the light-shielding layer in order to prevent the crack.

The thickness of the above-mentioned base material can be appropriately selected depending on the thickness of the light-shielding film. For example, if glass is used as the base material, the glass preferably has a thickness of 30 to 500 μm and more preferably more than 100 μm. If a resin is used as the base material, a film of polyimide, kapton, and the like, having a thickness of less than 100 μm is preferable, although a sheet thereof having a thickness of about less than 100 μm can be also preferably used.

It is preferable that the base material has heat resistance. It is more preferable that the base material is a heat-resistant resin film (film including a heat-resistant resin). With respect to the heat resistance temperature of the base material, the base material has a 10% decomposition temperature of 200° C. or more, and more preferably 250° C. or more, and still more preferably 300° C. or more, and most preferably 350° C. or more. The base material preferably has a Tg of 80° C. or more, and more preferably 150° C. or more, and still more preferably 200° C. or more, and most preferably 250° C. or more. Due to such a base material having reflow resistance, a light-shielding film having such a base material can be preferably automatically mounted.

The light-shielding film of the present invention is not especially limited as long as it includes the light-shielding layer. It is preferable that the light-shielding film includes other components if necessary. If the light-shielding film includes a layer having another function, for example, if an IR-cut layer is included, a low-reflective index material and a high-refractive index material (for example, an inorganic oxide) is deposited and stacked on the base material, generally. If heating is performed during the deposition, the base material needs to have heat resistance for heating during the deposition. Therefore, the use of the material having reflow resistance as the base material is preferable because the IR-cut layer can be easily formed. In addition, the base material might need sufficient heat resistance when a layer having functions other than the light-shielding layer is formed. If an IR-cut layer (an inorganic multilayer film, a film which reflects or shields IR) is formed by deposition, for example, the deposition is generally performed at a temperature of several hundreds degrees or more. Therefore, the base material (material for substrate) needs to have heat resistance. Accordingly, the use of the base material having sufficient heat resistance enables various IR-shielding materials to be formed by various methods.

In the present description, the “heat resistance” means a high resistance to heat. For example, it is preferable that the material such as the organic resin satisfies at least one of a high Tg and a high decomposition temperature (preferably, a high 10% decomposition temperature). It is preferable that the base material, the light-shielding film, and the lens unit each satisfy at least one of an excellent shape retentivity, a low dimensional change, and a high decomposition temperature (preferably, a high 10% decomposition temperature).

The “reflow resistance” means a sufficient resistance to a temperature where the reflow step is performed. Similarly in the “heat resistance”, for example, it is preferable that the material such as the organic resin satisfies at least one of a high Tg and a high decomposition temperature (preferably, a high 10% decomposition temperature). It is preferable that the base material, the light-shielding film, and the lens unit each satisfy at least one of an excellent shape retentivity and a high decomposition temperature (preferably, a high 10% decomposition temperature). It is preferable that the Tg, decomposition temperature, shape retentivity and the like satisfy the above-mentioned characteristics, respectively.

The light-shielding film of the present invention is not especially limited as long as it is, as mentioned above, the light-shielding film including the organic resin and the black material, wherein the organic resin includes the cured product of the curable resin or the thermoplastic resin having a glass transition temperature of 150° C. or more. The light-shielding film is prepared by shaping the light-shielding resin composition including the black material and the organic resin raw material into a film. For example, the light-shielding film is prepared by shaping the light-shielding resin composition into a film by a publicly known coating method or a film-forming method such as a melt extrusion method. The method for producing the film may be appropriately selected depending on the kind, physical properties and the like of the organic resin.

The light-shielding film preferably has an embodiment in which at least one, preferably both surfaces of the film have roughness in order to suppress the light-shielding film from reflecting light. The following methods including a surface roughness-forming step are preferable as the method for producing the light-shielding film having a rough surface. That is, the present invention is a production method of a light-shielding film including an organic resin and a black material, wherein the production method includes a surface roughness-forming step of producing a light-shielding film having a rough surface by a transfer method by a transfer method. The use of such a production method makes it possible to form roughness finely and in a reproducible manner. As a result, embodiments of the roughness, such as a size and a depth, can be precisely controlled. That is, a surface which is excellent in flatness and which is provided with matte property attributed to the roughness that is uniformly and finely formed can be formed. That is to say, the production method of the light-shielding film including the organic resin and the black material is a production method of the light-shielding film, including a step of producing a light-shielding film having a rough surface (surface roughness-forming step) by a transfer method. That is, in the surface roughness-forming step, the light-shielding resin composition that is a raw material for the light-shielding film is shaped into a film and simultaneously the roughness are formed or the roughness are transferred to the light-shielding resin composition which has been shaped into a film, for example, as long as the roughness on the light-shielding film surface are formed by a transfer method. The way of forming the roughness and the order of steps and the like are not especially limited. The surface roughness-forming step is mentioned below in more detail.

The above-mentioned surface roughness-forming step is a step of producing the light-shielding film having a rough surface using a transfer layer having roughness with which the light-shielding film surface is provided (also referred to as a rough layer, a base material for transferring roughness, a transfer material). Specifically, it is preferable that the light-shielding resin composition containing the organic resin raw material and the black material (light-shielding layer-forming composition) is brought into contact with the above-mentioned transfer layer, thereby being provided with roughness. In this case, it is preferable that a light-shielding resin composition which is not solidified or cured or which has not completely solidified or cured is brought into contact with the above-mentioned transfer layer, and if necessary, drying, solidification, and curing are performed, and as a result, the roughness is formed.

The above-mentioned light-shielding resin composition includes the organic resin raw material and the black material. It is preferable that the black material is uniformly dispersed or dissolved in the light-shielding resin composition. The organic resin raw material and the black material are as mentioned above, preferably. Specifically, it is preferable that the organic resin raw material is a solvent-soluble organic resin raw material and includes the solvent. That is, it is preferable that the light-shielding resin composition includes the organic resin raw material, the black material, and the solvent. An embodiment in which the black material is uniformly dispersed or dissolved in the composition is permitted if the light-shielding resin composition contains the solvent. In this case, it is preferable that the black material is dispersed or dissolved in a solution in which the organic resin raw material (heat-resistant resin binder raw material) is finely dispersed or dissolved (for example, the black fine particles are uniformly dispersed to have a fine particle size) and the thus-prepared light-shielding resin composition is applied to form a light-shielding layer (black layer). According to such a manner, the light-shielding layer is uniformly blackened and it can exhibit an excellent light-shielding property.

The content of the black material in the above-mentioned light-shielding resin composition is preferably the same as mentioned above. That is, the black material content is preferably 1 to 50% by weight, and more preferably 1 to 40% by weight, and still more preferably 1 to 30% by weight in 100% by weight of the total amount of the black material and the organic resin raw material (solid content). Further, the total amount is preferably 3 to 40% by weight and more preferably 5 to 30% by weight.

It is preferable that the solid content (the total amount of the black fine particles and the organic resin raw material) in the above-mentioned light-shielding resin composition is 5 to 40% by weight in 100% by weight of the light-shielding resin composition. If the solid content is less than 5% by weight, the composition includes solvents much and therefore it takes longer time to dry the film. Further, aggregation and the like is generated in the composition, which might deteriorate the film thickness characteristics. If the solid content is more than 40% by weight, the composition has too high viscosity and therefore might not be coated as a film. The solid content is more preferably 10 to 35% by weight and still more preferably 15 to 30% by weight.

The above-mentioned solvents are preferably used as the solvent included in the above-mentioned light-shielding resin composition. Among these, cyclohexanone, 2-acetoxy-1-methoxypropane (PGMEA), ethyl acetate, N,N-dimethylacetamide, methyl ethyl ketone (MEK), methyl isobutyl ketone (MIBK), and 1-methyl-2-pyrrolidone (NMP) are preferable. Cyclohexanone, MIBK, PGMEA, MEK, and ethyl acetate are more preferable. It is preferable that the above-mentioned light-shielding resin composition has a viscosity of 1 to 1000000 cp (centipoise). More preferably, the viscosity is 50 to 500000 cp.

It is preferable in the above-mentioned production method of the light-shielding film that the surface roughness-forming step is performed simultaneously with and/or successively after the coating step. Thus, if the surface roughness-forming step is performed simultaneously with and/or successively after a coating step, the rough surface can be formed in a one-step process where the surface roughness-forming step is performed simultaneously with or successively after the coating step. Therefore, such a method is advantageous in that the production steps can be simplified or omitted, and the production time is shortened, and therefore the film is produced at low costs. The coating step means a step of applying the light-shielding resin composition. If the surface roughness-forming step is performed simultaneously with the coating step, it is preferable that the step of applying the light-shielding resin composition and the surface roughness-forming step are at least partly simultaneously performed. Examples of such a case include: a case where the step of applying the light-shielding resin composition and the surface roughness-forming step are simultaneously performed (the roughness is formed simultaneously with the coating); and a case where before completion of the step of applying the light-shielding resin composition, the light-shielding resin composition which has been already coated is subjected to the surface roughness-forming step. If the surface roughness-forming step is performed successively after the coating step, the coating step and the surface roughness-forming step are performed in a substantially continuous step. In this case, it is preferable that immediately after completion of the coating step, the surface roughness-forming step is performed. The surface roughness-forming step may be started a little later after completion of the coating step. For example, after completion of the coating step, the coated light-shielding resin composition may be left or dried before the surface roughness-forming step is started. That is, if the surface roughness-forming step is performed successively after the coating step, it is preferable that steps other than the steps where the light-shielding resin composition is left until the next step is started and where the coated light-shielding resin composition is dried are not exist between the coating step and the surface roughness-forming step.

In the above-mentioned surface roughness-forming step, it is preferable that the light-shielding resin composition is brought into contact with the transfer layer, thereby being provided with the roughness. Specific methods may be appropriately selected depending on the components included in the light-shielding resin composition or characteristics of the composition. For example, the following transfer methods may be used.

Transfer method (1): a composition-applied layer (film) with roughness is prepared by applying the light-shielding resin composition on a transfer layer (for example, a base material having a rough surface), and then the composition-applied layer (film) is dried and solidified, or cured or reacted (reacted with polyamic acid to become polyimide, for example) (this method is also referred to as a base material mold-transfer method). In this case, the shaped light-shielding resin composition layer (film) is separated from the transfer layer after the roughness is formed, generally. Either frosted glass or a matte film (PET having a rough surface and the like) is preferable as the transfer layer.

Transfer method (2): the light-shielding resin composition is previously formed into a film, and the film is turned into a chemically and compositionally intermediate state, or semi-dried, semi-cured, or non- or semi-reacted state, and after that, such a film is brought into contact with a transfer layer, thereby forming the film surface with roughness. In this case, any of frosted glass, a matte film (PET having a rough surface), and a matte roll is preferable as the transfer layer.

Transfer method (2′): the light-shielding resin composition is formed into a film, and the film is turned into a chemically or compositionally final state and then completely dried, solidified, cured, or reacted, and such a film is brought into contact with a transfer layer. In this case, frosted glass and a matte film (PET having a rough surface and the like) are preferable as the transfer layer. If the organic resin is a thermoplastic resin (polyimide, PEEK, and the like), according to the transfer method (2′), it is preferable that the roughness is formed by pressing the transfer layer against the resin, thereby bringing the resin into contact with the transfer layer under heating (by a matte roll treatment, heating the resin sandwiched between frosted glasses, and the like).

That is, as in the transfer methods (2) and (2′), a method in which the light-shielding resin composition is previously formed into a film and such a film is brought into contact with the transfer layer, thereby being provided with the roughness, is mentioned as a preferable transfer method.

The above-mentioned transfer method (1) is a method of forming roughness before or while the light-shielding resin composition layer (film) is dried and solidified, or before or while the light-shielding resin composition layer (film) is cured and reacted.

The following cases are preferable as the above-mentioned transfer method (1): the organic resin is a thermoplastic resin having a Tg of 150° C. or more; and the organic resin raw material is a solvent-soluble organic resin raw material and the light-shielding resin composition is composition prepared by dissolving the organic resin raw material in the solvent. Preferable embodiments of the former case (the roughness is formed before or while the light-shielding resin composition is dried and solidified) include an embodiment in which the organic resin raw material is a thermoplastic resin having a Tg of 150° C. or more. Preferable embodiments of the latter case (the roughness is formed before or during the light-shielding resin composition is cured and reacted) include an embodiment in which the organic resin raw material is a curable resin (precursor) such as polyamic acid or a thermoplastic resin precursor having a Tg of 150° C. or more; and an embodiment in which the organic resin raw material is a curable resin such as a polyfunctional epoxy compound. Among these, it is preferable that the light-shielding resin composition is a composition including a solvent-soluble organic resin raw material because of ease of handling. These embodiments can be preferably employed, for example, if the organic resin raw material is a curable resin. The polyamic acid can be preferably used in both cases where a thermosetting polyimide is obtained and a thermoplastic polyimide is obtained. Thus, a liquid composition is also preferably used in the transfer method (1), which is different from the following transfer methods (2) and (2′). That is, as performed in the transfer method (1), the preferable embodiments include an embodiment in which the surface roughness-forming step includes a step of forming a coating film made of the light-shielding resin composition on a transfer layer.

As the method of forming the roughness in the above-mentioned transfer method (1), publicly known coating methods such as a solvent-casting method, a spin coating method, a bar coater method, a roll coater method, a gravure coater method, and a knife coating method.

The above-mentioned transfer method (2) is a method in which the light-shielding resin composition is previously formed into a film, and the film is turned into a chemically and compositionally intermediate state, or semi-dried, semi-cured, or non- or semi-reacted state, and after that, such a film is brought into contact with a transfer layer, thereby being provided with roughness. Accordingly, the drying and solidifying, or curing step is not necessarily performed in the process of forming the roughness. According to the transfer method (2), the roughness is formed and then, the applied film is dried and solidified or cured, and alternatively the drying and solidifying or curing may be performed while the roughness is formed. It is preferable that the drying and solidifying, or curing is performed while the roughness is formed in order to transfer the roughness of the transfer layer to the film with more accuracy. In the transfer method (2), the condition that “the light-shielding resin composition is previously semi-dried and semi-cured” means that the light-shielding resin composition which is to be subjected to the transfer method (2) is ready to be provided with the roughness by contact with the transfer layer. It is preferable that the composition is in a semi-dried or semi-cured state if the organic resin is a curable resin. If the organic resin is a thermoplastic resin, the shape of the composition is not especially limited as long as it has a strength high enough for the roughness to be formed under heating. For example, it is preferable that the composition is shaped into a desired shape such as a filter.

In the above-mentioned transfer method (2), the light-shielding resin composition is applied on the base material and then semi-dried and semi-cured when the composition is previously semi-dried and semi-cured. The use of the matte roll as the transfer layer permits continuously performing the coating.

The above-mentioned transfer method (2) is preferably used if the light-shielding resin composition is semi-dried or semi-cured, for example, in the following cases where the organic resin raw material is a curable resin; and the organic resin raw material is a thermoplastic resin having a Tg of 150° C. or more. A roll transfer method and a pattern transfer method are preferable as a method of forming the roughness in the transfer method (2).

The transfer method (2′) is a method in which the light-shielding resin composition is previously formed into a film, and the film is turned into a chemically or compositionally final state (the film is completely dried, solidified, cured, or reacted), and such a film is brought into contact with a transfer layer. Accordingly, the drying and solidifying step, or the curing step are/is not needed in the process of forming the roughness. Similarly in the transfer method (2), a roll transfer method and a pattern transfer method are preferable as a method of forming the roughness in the transfer method (2′).

The preferable embodiments of the present invention include: an embodiment in which the surface roughness-forming step includes a step of bringing a film made of the light-shielding resin composition into contact with the transfer layer as in the transfer method (2); and an embodiment in which the surface roughness-forming step includes a step of bringing the light-shielding film (film which has been dried, solidified, cured, or reacted) into contact with the transfer layer, as in the transfer method (2′).

It is also preferable that the above-mentioned surface roughness-forming step has an embodiment in which two or more of the transfer methods (1), (2), and (2″) are appropriately combined and used (also referred to as a transfer method (3)) is preferable. As the transfer method (3), an embodiment in which the transfer method (1) is combined with the transfer method (2) or (2″) is preferable. If the transfer method (1) is combined with the transfer method (2) or (2′), one rough surface of the film is formed by the transfer method (1), and by the transfer method (2) or (2′), the other rough surface of the film is formed. As a result, both surfaces of the light-shielding film can be formed to be rough surfaces. The transfer method (1) and the transfer method (2) or (2′) are simultaneously and/or successively performed, and as a result, the both rough surfaces of the light-shielding film are simultaneously and/or successively formed. Thus, the preferable embodiments of the present invention include the production method of the above-mentioned light-shielding film, wherein in the surface roughness-forming step, one rough surface of the light-shielding film and the other rough surface of the light-shielding film are simultaneously and/or successively formed. If in the surface roughness-forming step, the both rough surfaces of the light-shielding film are simultaneously prepared, it is preferable that one rough surface and the other rough surface are at least partly simultaneously formed.

If the transfer method (1) and the transfer method (2) or (2′) are successively performed in the above-mentioned transfer method (3), an embodiment in which one transfer method is performed and immediately the other transfer method is performed is preferable. However, one transfer method is performed and after a certain time, the other transfer method is performed. Such a time interval can be appropriately determined depending on the used materials and the like. A time interval which is employed in a commonly used production method can be preferably used if the both rough surfaces of the light-shielding film are successively formed.

If the above-mentioned transfer method (1) and the transfer method (2) or (2′) are successively performed, an embodiment in which the transfer method (1) is performed and then the transfer method (2) or (2′) is performed. If the organic resin is a curable resin, for example, one rough surface of the light-shielding film is formed and simultaneously the light-shielding resin composition is turned into a semi-dried and semi-cured state or in a completely dried and solidified or cured state by the transfer method (1), and successively, by the transfer method (2) or (2′), the other rough surface of the light-shielding film can be formed. If the organic resin is a thermoplastic resin, one rough surface of the light-shielding film is formed and simultaneously the light-shielding resin composition is dried and solidified by the transfer method (1), and successively, heating is performed again to form the other rough surface of the light-shielding film by the transfer method (2) or (2′). The light-shielding film obtained by such a method shows a smaller dimensional change and more excellent heat resistance than those of a light-shielding film prepared by only the transfer method (1). Thus, the preferable embodiments of the present invention are also an embodiment in which the surface roughness-forming step is performed in accordance with the transfer method (3).

In the above-mentioned surface roughness-forming step, the light-shielding resin composition is shaped (dried and solidified or cured) into a film, and then the rough surface is formed by a sandblasting treatment (also referred to as a transfer method (4)). If the light-shielding resin composition is shaped into a film, it is preferable that the light-shielding resin composition is applied on the above-mentioned base material and then dried and solidified or cured.

One or more of the above-mentioned transfer methods (1) to (4) can be appropriately selected and used depending on the light-shielding resin composition, the produced light-shielding film, and the like. According to the transfer methods (1) to (3), uniform and fine roughness can be formed stably, and therefore the controllability of the size and embodiment of the roughness is excellent (the size and the embodiment are not varied), and further not only excellent flatness but also the matte property are provided for the film. In the above-mentioned two points, the transfer methods (1) to (3) are preferable. The method (3) is more preferable.

According to the above-mentioned transfer methods (1) to (4), the base material and/or the transfer layer (roughness-giving layer) might be integrated with the light-shielding resin composition in the surface roughness-forming step. Such a base material and/or a transfer layer may constitute a part of the light-shielding film, or may be removed. The transfer layer is generally removed (separated), and if necessary the base material is removed. In the above-mentioned transfer method (1) or (3), the light-shielding film which is a single layer composed of the light-shielding layer and has a rough surface can be obtained after the base material is removed. Thus, according to the transfer method (1) or (3), the single-layer film having controlled roughness can be obtained even though the coating method is adopted.

The base materials mentioned above can be preferably used as the above-mentioned base material. It is preferable that the base material is excellent in demolding property because the base material is separated from the light-shielding film after the roughness is formed. Further, it is also preferable that the light-shielding resin composition is applied on a smooth base material, and the composition is turned into a dried state from a semi-dried state, or into a solidified state from a semi-solidified state, or into a cured state from a semi-cured state, or into an organic resin state from a precursor state, and then the obtained film is separated from the base material, and then the rough surface of the light-shielding film is formed by the transfer method (2), (2′), or (4). In this case, it is preferable that the obtained film surface not in contact with the base material is subjected to the above-mentioned surface roughness-forming step because a film having a low glossiness can be easily obtained. According to the above-mentioned film obtained by applying the light-shielding composition on a smooth base material, the surface in contact with the base material has a high glossiness, but, possibly because of volatilization of the solvent, the surface not in contact with the base material has a low glossiness than that of the above-mentioned surface in contact with the base material. Accordingly, if the transfer method (2), (2′) or (4) is adopted, it is preferable that the surface not in contact with the base material is subjected to the transfer treatment because a light-shielding film having a low glossiness (20 or less) is easily obtained. It is preferable that both of the surfaces are subjected to the transfer treatment, of course.

Preferable examples of the material for the above-mentioned transfer layer (transfer member) include: frosted glass; and matte films (a polymer film provided with a matte treatment) such as a PET film provided with a matte treatment (a matte PET film), a PP film provided with a matte treatment, and a matte PC film. Such materials can be preferably used in the above-mentioned transfer methods (1) to (3), particularly (1) and (3). It is preferable that the transfer layer is excellent in demolding property because it is separated, from the light-shielding film, generally.

With regard to the roughness characteristics of the matte film, it is preferable that Ra is 1.0 μm or more, Ry is 10 μm or more, Rz is 10 μm or more, and S is 3 μm or less. It is more preferable that Ra is 1.5 μm or more, Ry is 20 μm or more, Rz is 15 μm or more, and S is 2 μm or less.

Transfer layers in various embodiments such as a plate transfer layer, a matte transfer layer, and a matte roll transfer layer can be used as the above-mentioned transfer layer. Particularly in the above-mentioned transfer method (2), a matte roll transfer layer is preferably used. The roll surface is provided with roughness by roll coating, and thereby the film can be continuously produced, leading to reduction in production costs.

The embodiment of the roughness of the above-mentioned transfer layer is preferably the same as that of the above-mentioned roughness of the light-shielding film.

The light-shielding film is preferably produced by the above-mentioned production method of the present invention. Thus, the preferable embodiments of the present invention include a light-shielding film produced by the above-mentioned production method.

One preferable embodiment of the light-shielding film of the present invention is mentioned with reference to drawings. The transfer method (3) is preferably used as the transfer method. A matte roll is preferably used as the transfer layer. Such an embodiment is schematically shown in FIG. 9. The use of the matte roll coating enables the both surfaces to form both rough surfaces of the light-shielding film. The light-shielding resin composition is applied on a transfer layer 11, and while the applied composition is semi-dried or semi-cured, one rough surface in contact with the transfer layer 11 is formed, if necessary, by pressing a roll 9 against the surface. While the semi-dried or semi-cured state is maintained, the light-shielding resin composition is brought into contact with a matte roll transfer layer 10, and thereby the other rough surface is formed, and then the transfer layer 11 is separated. As a result, a light-shielding film having a single-layer structure in which the both surfaces are rough surfaces can be continuously produced.

The present invention is also a lens unit including the light-shielding film and a lens, wherein the lens unit has reflow resistance. The lens unit of the present invention is useful in an optical application or an opto device application, and further in a display device application, or useful as a mechanical component, an electrical and electronic component, and the like.

In the above-mentioned lens unit, the light-shielding film is a film which suppresses optical noise from being generated and spread inside the lens unit and which removes the generated optical noise. The light-shielding film mentioned above is preferable as a light-shielding film in the above-mentioned lens unit. That is, an organic resin included in the light-shielding film preferably contains a cured material of a curable resin or a thermoplastic resin having Tg of 150° C. or more. If the organic resin is the above-mentioned resin, a light-shielding film having reflow resistance can be obtained and such a film can be preferably used in a lens unit having reflow resistance. Other preferable examples and preferable embodiments of the light-shielding film are as mentioned above. The above-mentioned lens unit includes the light-shielding film and a lens. The numbers of the light-shielding film and the lens may be appropriately determined depending on the application of the lens unit and the like as long as the lens unit includes one each. The lens unit may include a plurality of films and lenses. In the present description, the “lens unit having reflow resistance” is a lens unit including a light-shielding film having at least excellent shape retentivity. As a preferable embodiment, similarly in the shape retentivity of the above-mentioned light-shielding film, an embodiment in which a change in each dimension (dimensional change) of the light-shielding film between before and after heating at 200° C. for 1 minute is 10% or less is mentioned. Further, an embodiment in which the change in each dimension (dimensional change) of the light-shielding film between before and after heating at 260° C. for 2 minutes is 10% or less is more preferable. Under any conditions, the dimensional change is more preferably 5% or less, and still more preferably 3% or less, and particularly preferably 1% or less.

In the above-mentioned lens unit, the lens is made of a shapeable material which transmits light at a wavelength in a visible light region. Any of organic materials, inorganic materials, and organic and inorganic composite materials may be used as the material for the lens. One or more different materials of them may be used. An organic material having excellent processability (e.g., a thermoplastic resin composition and a curable resin composition) is preferable as the above-mentioned organic materials. An inorganic material having excellent transparency and coefficient of thermal expansion (e.g., glass) is preferable as the above-mentioned inorganic materials. An organic-inorganic composite material having the both characteristics (e.g., an organic-inorganic composite resin composition) is preferable as the above-mentioned organic-inorganic composite materials. A lens made of any of the materials can be preferably used, but a material having reflow resistance (heat-resistant material) is preferable.

Thus, the preferable embodiments of the present invention include an embodiment in which the light-shielding film and the lens constituting the lens unit have reflow resistance. If each of the light-shielding film and the lens has sufficient heat resistance, the lens unit can be automatically mounted, which leads to a sufficient reduction in mounting costs. Therefore, such a lens unit can be preferably used in an optical application such as a camera module. Thus, the light-shielding film of the present invention is preferably used in an imaging lens unit used in a camera module. Particularly in an imaging lens unit used in a camera module which is subjected to a soldering reflow step, the light-shielding film can be preferably used. That is, it is preferable that the above-mentioned lens unit is an imaging lens unit used in a camera module. It is particularly preferable that the above-mentioned lens unit is an imaging lens unit used in a camera module subjected to a soldering reflow step.

Preferable organic materials which are used as a material for the above-mentioned lens are specifically mentioned below. Because of excellent colorless transparency and heat resistance, the following materials are mentioned. Cured products of curable resins: a material prepared by curing a curable resin composition including a resin (raw material) mainly containing a compound having at least one epoxy group (an epoxy group-containing compound); and a material prepared by curing a curable resin composition including a resin (raw material) mainly containing a compound having a polymerizable unsaturated bond. Thermoplastic resins having a Tg of 150° C. or more: a material prepared by curing a curable resin composition including a resin (raw material) mainly containing a phenol resin; a material prepared by curing a curable resin composition including a resin (raw material) mainly containing a silicone resin; a silicone thermoplastic resin; a polycycloolefin resin; and a polycarbonate resin. The curing means publicly known curing such as thermal curing or curing by irradiation of active energy ray. The curable resin composition includes, in addition to the above-mentioned main compound, a publicly known material such as a curing catalyst, a curing accelerator, and a curing agent, each for accelerating curing. With regard to the above-mentioned main compound, the curable resin composition contains 70% by weight or more of the above-mentioned main compound relative to the total amount of the resin (raw material).

The material prepared by curing a curable resin composition including a resin (raw material) mainly containing an epoxy group-containing compound is particularly preferable as the above-mentioned material. The embodiments of the compounds similar to the epoxy group-containing compound and the compound having a polymerizable unsaturated bond, mentioned above in the light-shielding resin composition for the light-shielding film, can be applied to the epoxy group-containing compound and the compound having a polymerizable unsaturated bond.

The above-mentioned preferable organic materials are preferable as the organic material component of the above-mentioned organic-inorganic composite material.

It is preferable that the lens is obtainable by curing the curable resin composition. The lens obtained using the curable resin composition can be inexpensively subjected to complicated processes which can not be performed for an inorganic material (e.g., glass). Further, such a lens has heat resistance which a lens obtained using a thermoplastic resin composition can not obtain. Such a lens can be preferably subjected to industrial production steps such as processing (shaping) and mounting on a lens unit, and therefore the production steps can be efficiently performed. Thus, the use of the curable resin composition has the above-mentioned advantages. In addition, the above-mentioned lens is preferably obtained by curing the curable resin composition, and further it is preferable that the curable resin composition includes, as a organic resin component, a compound containing at least one epoxy group. Further, it is more preferable that the curable resin composition is also an organic-inorganic composite resin composition containing an inorganic component.

In the present invention, as mentioned above, it is preferable that the lens is obtainable by curing the curable resin composition. Thus, the preferable embodiments of the present invention also include a lens unit including the light-shielding film and the lens, wherein the lens unit has reflow resistance, and the lens is obtainable by curing the curable resin composition. Among these, a lens prepared by cationically curing a curable resin composition which includes an epoxy group-containing compound as a main resin raw material and a cationically curing catalyst such as a thermosetting curing agent.

Compounds mentioned in the following epoxy group-containing compound exemplified as the organic resin raw material included in the light-shielding film can be preferable used as the above-mentioned compound containing at least one epoxy group. Among these, the following resins are preferable: epibis glycidyl ether epoxy resins; novolac aralkyl glycidyl ether epoxy resins; aromatic crystal epoxy resins; aliphatic glycidyl ether epoxy resins; epoxy cyclohexane skeleton-having epoxy resins; glycidyl ester epoxy resins; and tertiary amine-containing glycidyl ether epoxy resins. A curable resin containing a non-curable component such as a thermoplastic resin and a low-molecular-weight curable compound can be used. With regard to the use embodiment of the above-mentioned curable resin composition (thermosetting epoxy resin composition) used in the lens, an embodiment mentioned in the following light-shielding film is preferably used. Particularly, an embodiment in which a thermal-latent curing catalyst is used is preferable. The curable resin composition is used in a lens application. It is preferable that the curable resin composition contains no black fine particles which are included in the curable resin composition used for forming the light-shielding film.

It is preferable that the above-mentioned organic-inorganic composite resin composition includes an organic resin, and inorganic fine particles or organopolysiloxane. The following embodiments of the organic resin are preferable. An embodiment in which the organic resin has an Abbe number of 45 or more if an organic resin having a high Abbe number is used, an embodiment in which the organic resin is a curable resin, an embodiment in which the organic resin includes an alicyclic epoxy compound, and an embodiment in which the organic resin has a molecular weight of 700 or more. The following embodiments of the inorganic fine particles are preferable. An embodiment in which the inorganic fine particles are obtained by a wet method, and an embodiment in which the inorganic fine particles have an average particle size of 400 nm or less, and an embodiment in which the inorganic fine particles have a pH of 3.4 to 11 at 25° C. when being dispersed in a solution. As the embodiment of the organic-inorganic resin composition, an embodiment in which the composition contains 10% by weight or less of an unsaturated bond and an embodiment in which the composition contains a flexible component are preferable.

It is preferable that the lens has a thickness of less than 1 mm. If the lens has a thickness (the maximum thickness in a region where an image is reflected) of less than 1 mm and further the light-shielding film is used, the optical path length can be shortened and therefore the lens unit can become smaller. The thickness of the lens is more preferably less than 800 μm and still more preferably less than 500 μm.

The Abbe number of the above-mentioned lens is not especially limited. For example, if the lens has an Abbe number of 45 or more, dispersion of light becomes smaller, and the resolution is increased. Therefore, the lens can be excellent in optical characteristics. If the lens has an Abbe number of less than 45, blurring (occurrences of aberration) might be observed, and sufficient optical characteristics are not exhibited, for example. Therefore, such a lens might not be preferably used in a lens unit. The above-mentioned Abbe number is more preferably 50 or more, and still more preferably 55 or more, and particularly preferably 58 or more, and most preferably 60 or more.

With regard to the lens constituting the above-mentioned lens unit, the optical characteristics (Abbe number, refractive index, and the like) and the shape (concavo or convex shape, a curvature and the like) of the lens are controlled and one or more of such lenses are used depending on a desired resolution. One or more lenses can be used. If one lens is used, a lens having a high Abbe number is preferably used because dispersion of light becomes smaller, and the resolution is increased, and as a result, the lens unit can show excellent optical characteristics. If two or more lenses are used in combination, any various combinations can be adopted. For example, it is preferable that a lens having a high Abbe number and a lens having a low Abbe number are used in combination.

The above-mentioned lens unit is not especially limited as long as it includes the light-shielding film and the lens. An embodiment in which the lens unit includes other members such as an IR-cut filter, a CMOS sensor, a barrel, and an adhesive. The adhesive is used to fix the members such as the lens and the light-shielding film to the unit.

The arrangement of each component of the above-mentioned lens unit is not especially limited as long as the characteristics as the lens unit are exhibited. It is preferable in the light-shielding film that the light-shielding layer is attached to the edge for fixing the lens, as mentioned above. With regard to the positional relationship between the light-shielding film and the lens, an embodiment in which the lens is arranged on the side where light enters and an embodiment in which the light-shielding film is arranged on the side where light enters may be mentioned. It is preferable that at least one light-shielding film is arranged closer to the side where incident light enters than the lens in order to absorb light reflected by the lens surface.

With regard to the shape of the above-mentioned light-shielding film, it is preferable that the light-shielding layer has a ring shape and nothing is formed in the center of the ring. Due to such arrangement and shape, the light-shielding functions can be sufficiently exhibited. Specifically, as schematically shown in FIG. 10(b), if the lens unit has the light-shielding film whose center is formed of a transparent film, the optical path length is increased. However, as schematically shown in FIG. 10(a), if the lens unit has the hollow light-shielding film, the optical path length is not increased. The lens unit needs to be downsized, and therefore, the lens unit preferably has an embodiment in which the light-shielding layer has a ring shape and nothing is formed in the center of the ring. If the light-shielding film is arranged between a lens and a CMOS sensor, the optical path length is decreased by reducing the thickness of the light-shielding film. As a result, the lens unit can be downsized and thinned.

With regard to the arrangement of the light-shielding film and the lens in the lens unit, as shown in FIG. 6, an embodiment in which the light-shielding film, one or more lenses, and the CMOS sensor are arranged in this order in the moving direction of incident light. If the lens unit includes two or more lenses, an embodiment in which each lens has the light-shielding film is more preferable. Unnecessary light can be sufficiently shielded if the lens unit includes a plurality of light-shielding films. The light-shielding film may be arranged between the lenses. If the lens unit includes other functional layers such as an IR-cut filter mentioned below, it is preferable that such layers are arranged in such a way that effects attributed to such layers are sufficiently exhibited. In FIG. 6, the IR-cut filter is arranged at a position closest to the CMOS sensor. The IR-cut filter may be arranged to be positioned on the lens unit surface where light enters.

With regard to the size of the lens unit of the present invention, it is preferable that the lens unit is small because such a small lens, unit can be preferably used in various applications. It is preferable that the above-mentioned lens unit has a thickness of 50 mm or less. The lens unit having such a thickness can be preferably used in various optical members such as a camera module. The thickness of the lens unit is more preferably 30 mm or less and still more preferably 10 mm or less.

If the light-shielding film whose center is formed of a transparent film is used, the length of the above-mentioned lens unit can be smaller as the light-shielding film between the lens and the CMOS sensor is thinner. Specifically, a camera module includes the light-shielding film, the lens, and a CMOS sensor. FIGS. 6 and 10 each schematically show one example of the camera module. These figures are referred to documents in Electronic Journal the 81th Technical Seminar. If the light-shielding film in the camera module is arranged as shown in FIG. 10(b), the focal length is increased and the back focus is extended. As a result, the module gets larger. As shown in FIG. 10(b), if the light-shielding film is arranged on the surface where light enters and between the lens and the CMOS sensor, and the thickness of the light selective transmission filter is defined as t and the refractive index n is about 1.5, the back focus is extended by about t/3, and thereby the module gets larger. However, if the thickness of the light-shielding film is reduced and the focal length is decreased, the module can be downsized. Accordingly, it is preferable that the optical path length of an optical member in 1/10 inch accounts for 120% or less relative to an optical member not including the light-shielding film. The optical path length is preferably 110% or less and still more preferably 105% or less.

The light-shielding resin composition used for forming the light-shielding film of the present invention and the resin composition that is a raw material for forming the organic resin constituting the light-shielding film (the composition including the organic resin raw material and other components before curing or shaping) are mentioned in more detail below. As mentioned above, the organic resin included in the light-shielding film of the present invention is the cured product of the curable resin or the thermoplastic resin having a Tg of 150° C. or more. Specifically, the above-mentioned organic resin can be preferably used. A compound containing at least one epoxy group, a polyphenol compound, a compound having a polymerizable unsaturated bond, a polyimide resin, and the like are preferable as the curable resin which forms the cured product. These compounds are mentioned below in more detail. A polyimide resin can be also used as the curable resin which forms the cured product, or the thermoplastic resin having a Tg of 150° C. or more.

If the organic resin included in the light-shielding film of the present invention is a thermoplastic resin having a Tg of 150° C. or more, the organic resin may be the same as the organic resin raw material. The above-mentioned organic resin can be used. If the organic resin is a cured product of a curable resin such as an epoxy resin and a polyimide resin, a curable resin which is appropriate to each resin can be used as the organic resin raw material.

The compound containing at least one epoxy group which can be preferably used as the organic resin raw material included in the light-shielding resin composition of the present invention is mentioned below.

The following compounds and the like are preferable as the above-mentioned compound containing at least one epoxy group. Epibis glycidyl ether epoxy resins obtained by condensation reaction of epihalohydrin with a bisphenol such as bisphenol A, bisphenol F, bisphenol S, and fluorene bisphenol, and high molecular weight epibis glycidyl ether epoxy resins obtained by further adding the above-mentioned bisphenol such as bisphenol A, bisphenol F, bisphenol S, and fluorene bisphenol into such epibis glycidyl ether epoxy resins; novolac aralkyl glycidyl ether epoxy resins obtained by a condensation reaction of epihalohydrin with polyphenol obtained by a condensation reaction of a phenol such as phenol, cresol, xylenol, naphthol, resorcin, catechol, bisphenol A, bisphenol F, bisphenol S, and fluorene bisphenol with formaldehyde, acetoaldehyde, propionaldehyde, benzaldehyde, hydroxy benzaldehyde, salichlaldehyde, dicyclopentadiene, terpene, coumarin, paraxylylene glycol dimethyl ether, dichroloparaxylylene, or bishydroxymethyl biphenyl; aromatic crystalline epoxy resins obtained by a condensation reaction of epihalohydrin with tetramethylbiphenol, teteramethylbisphenol F, hydroquinone, naphthalenediol, and the like, and high molecular weight aromatic crystalline epoxy resins obtained by further adding the above-mentioned bisphenol, tetramethylbiphenol, tetramethylbisphenol F, hydroquinone, or naphthalenediol into such aromatic crystalline epoxy resins; aliphatic glycidyl ether epoxy resins obtained by a condensation reaction of epihalohydrin with the above-mentioned bisphenol, alicyclic glycol having a hydrogenated aromatic skeleton such as tetramethylbisphenol, tetramethylbisphenol. F, hydroquinone, and naphthalenediol, ethylene glycol, diethylene glycol, triethylene glycol, tetraethylene glycol, PEG600, propylene glycol, dipropylene glycol, tripropyrene glycol, tetrapropylene glycol, PPG, glycerol, diglycerol, tetraglycerol, polyglycerol, trimethylolpropane and its polymer, pentaerythritol and its polymer, mono/polysaccharides, such as glucose, fructose, lactose, and maltose; epoxy resins having an epoxycyclohexane skeleton such as (3,4-epoxycyclohexane)methyl 3′,4′-epoxycyclohexylcarboxylate; glycidyl ester epoxy resins obtained by a condensation reaction of epihalohydrin with tetrahydrophthalic acid, hexahydrophthalic acid, or benzoic acid; and tertiary amine-containing glycidyl ether epoxy resins in the form of a solid at a room temperature, obtained by a condensation reaction of epihalohydrin with hydantoin, cyanuric acid, melamine, or benzoguanamine. Among these, the above-mentioned aliphatic glycidyl ether epoxy resins and epoxy resins having an epoxycyclohexane skeleton are more preferably used in order to suppress deterioration in appearance, caused by light irradiation.

It is preferable that the above-mentioned compound containing at least one epoxy group is a compound having flexibility. If the organic resin raw material includes such a compound having flexibility, such a raw material is excellent in handling in processing and shaping steps, for example. Such a raw material containing the epoxy group-containing compound having flexibility is particularly preferably used when being shaped into a film and the like. Specifically, the following compounds are preferable as the epoxy group-containing compound having flexibility. A compound having an oxyalkylene skeleton represented by —[—(CH₂)ₙ—O—]ₘ— (n representing an integer of 2 or more; m representing an integer of 1 or more; preferably, n being an integer of 2 to 12, and m being an integer of 1 to 1000; and more preferably, n being an integer of 3 to 6, and m being an integer of 1 to 20); a high-molecular epoxy resin such as hydrogenated bisphenol epoxy resin (product of Japan Epoxy Resins Co., Ltd., YL-7170, the epoxy equivalent: 1000, a solid hydrogenated epoxy resin); an epoxy resin containing oxybutylene as the oxyalkylene skeleton (product of Japan Epoxy Resins Co., Ltd., YL-the 7217, the epoxy equivalent 437, a liquid epoxy resin (10° C. or more) and YED-216D, product of Japan Epoxy Resins Co., Ltd.); a phenoxy resin (e.g., product of Japan Epoxy Resins Co., Ltd., YX-8100BX, YX6954BX and the like); an alicyclic solid epoxy resin (product of DAICEL INDUSTRIES, LTD., EHPE-3150); and an alicyclic liquid epoxy resin (product of DAICEL INDUSTRIES, LTD., CELLOXIDE 2081). Among these, a compound containing an epoxy group at the end, side chain, or main chain skeleton is more preferable. Thus, the preferable embodiments of the present invention include an embodiment in which the compound containing at least one epoxy group has flexibility.

In the present invention, a curable resin containing a non-curable component such as a thermoplastic resin and a low-molecular-weight curable compound can be used. Examples of the thermoplastic resin include polyethylene, polypropylene, polystyrene, acrylonitrile-styrene copolymer (AS resin), ABS resin consisting of acrylonitrile, butadiene, and styrene, vinyl chloride resin, (meth)acrylic resin, polyamide resin, acetal resin, polycarbonate resin, polyphenylene oxide, polyester, and polyimide. As the above-mentioned curable compound, compounds appropriately selected from the exemplified polyphenol compounds, compounds having a polymerizable unsaturated bond, polyimide resins, and compounds containing at least one epoxy group are used.

It is preferable that the organic resin is prepared by cationic curing using a thermal-latent cation generator if as the resin composition of the present invention, the organic resin raw material contains at least one epoxy group. That is, the preferable embodiments of the present invention include a cationic curable resin composition, wherein the organic resin raw material contains at least one epoxy group and the resin composition includes a thermal-latent cation generator. The thermal-latent cation generator is also called a cation polymerization initiator. Such a thermal-latent cation generator which is included in the resin composition exhibits substantial functions as a curing agent at a curing temperature. The use of such a thermal-latent cation generator can prevent progression of curing at a room temperature even if an organic resin raw material which promotes curing at a room temperature is used. As a result, the curing reaction can be easily handled. Further, due to the use of the above-mentioned thermal-latent cation generator, a cured product (the organic resin, the light-shielding layer) obtained from the resin composition has drastically improved moisture resistance and maintains the excellent optical characteristics attributed to the resin composition even in a harsh use environment. Therefore, such a cured product can be preferably used in various applications. Generally, moisture with a high refractive index, which is contained in the resin composition or the cured product, causes turbidity and a reduction in blackness. However, if the cationic curable resin composition is used, excellent moisture resistance can be exhibited, which suppresses such turbidity and a reduction in blackness. Therefore, such a cationic curable resin composition can be preferable used in a light-shielding film and an optical application such as a lens. Particularly in applications such as an in-vehicle camera and a bar-code reader for delivery service, yellowing or deterioration of strength may be caused due to long-time ultraviolet irradiation or exposure to summer high temperatures. These phenomena are caused because air or moisture is irradiated with ultraviolet or exposed to heat and such a synergistic effect generates oxygen radicals. The improved moisture resistance suppresses the cured product of the resin composition from absorbing moisture, and therefore, generation of oxygen radicals, attributed to the synergistic effect of the ultraviolet irradiation or the heat exposure, can be suppressed. Therefore, the cured product of the resin composition exhibits excellent heat resistance for a long time without yellowing or decrease in strength.

It is preferable that the above-mentioned thermal-latent cation generator is represented by the following formula (1)

(R¹_{b}R²_{c}R³_{d}R⁴ₑZ)^{+m}(MXn)^{-m} (1)

in the formula, Z representing at least one element selected from the group consisting of S, Se, Te, P, As, Sb, Bi, O, N, and halogen elements; R¹, R², R³, and R⁴ being the same or different and each representing an organic group; b, c, d, and e being 0 or a positive number, and a total of b, c, d, and e being equal to a valency of Z; a cation (R¹_{b}R²_{c}R³_{d}R⁴ₑZ)^{+m} representing an onium salt; M representing a metal element or a metalloid element that is the center atom of a halide complex and being at least one selected from the group consisting of B, P, As, Al, Ca, In, Ti, Zn, Sc, V, Cr, Mn, and Co; X representing a halogen element; m being a net positive charge of a halide complex ion; and n being the number of a halogen element in the halogen complex ion.

Specific examples of an anion (MXn)^{-m} in the above formula (I) include tetrafluoroborate (BF⁴⁻), hexafluorophosphate (PF⁶⁻), hexafluoroantimonate (SbF⁶⁻), hexafluoroarsenate (AsF⁶⁻), and hexachloroantimonate (SbCl⁶⁻).

Further, an anion represented by the formula MXn (OH)⁻ may be used. Examples of other anions include a perchlorate ion (ClO₄⁻), a trifluoromethyl sulfite ion (CF₃SO₃⁻), a fluorosulfonate ion (FSO₃⁻), a toluenesulfonate ion, and a trinitrobenzene sulfonate ion.

Specific trade products of the above-mentioned thermal-latent cation generator include: diazonium salt products such as AMERICURE series (product of American Can Corp.), ULTRASET series (product of ADEKA Corp.), and WPAG series (product of Wako Pure Chemical Industries, Ltd.); iodonium salt products such as UVE series (product of General Electric Co.), FC series (product of 3M), UV9310C (product of GE Toshiba Silicones Co., Ltd.), Photoinitiator 2074 (product of Rhone-Poulenc Inc.), and WPI series (product of Wako Pure Chemical Industries, Ltd.); sulfonium salt products such as CYRACURE series (product of Union Carbide Corp.), UVI series (product of General Electric Co.), FC series (product of 3M), CD series (product of Satomer Co., lnc), optomer SP series and optomer CP series (product of ADEKA Corp.), San-Aid SI series (product of SANSHIN CHEMICAL INDUSTRY CO., LTD.), CI series (product of NIPPON SODA CO., LTD.), WPAG series (product of Wako Pure Chemical Industries, Ltd.), and CPI series (product of SAN-APRO Ltd.).

Examples of curing agents other than the thermal-latent cation generator include: acid anhydrides such as methyltetrahydrophthalic anhydride, hexahydrophthalic anhydride, methylhexahydrophthalic anhydride, pyromellitic anhydride, and methylnadic acid; various phenol resins such as a phenol novolac resin, a cresol novolac resin, a bisphenol A novolac resin, a dicyclopentadiene phenol resin, a phenol aralkyl resin, and a terpene phenol resin; various phenol resins such as polyphenol resins obtained by condensation reaction of various phenols with various aldehydes such as hydroxybenzaldehyde, crotonaldehyde, and glyoxal; BF₃ complexes, sulfonium salts, and imidazoles. One or more species of them may be used. Further, the preferable embodiments include an embodiment in which the above-mentioned compound containing at least one epoxy group is cured using a polyphenol compound mentioned below.

A curing accelerator may be used for curing the above-mentioned resin composition including the compound containing at least one epoxy group. Examples of such a curing accelerator include organic phosphorus compounds such as triphenylphosphine, tributylhexadecylphosphonium bromide, tributylphosphine, and tris(dimethoxylpenyl)phosphine. One or more species of them may be used.

The above-mentioned curing temperature is preferably 70 to 200° C. and more preferably 80 to 150° C. The curing time is preferably 1 to 15 hours, and more preferably 5 to 10 hours.

If the organic resin preferably used in the light-shielding film of the present invention is a polyimide resin, the polyimide resin is a cured product of a thermosetting polyimide resin or a thermoplastic polyimide resin. The raw material for such resins is not especially limited, as long as the raw material contains an imide ring. A thermosetting polyimide resin is preferable and a thermosetting aromatic polyimide is more preferable in view of productivity, production costs, and heat resistance, if the light-shielding film of the present invention is prepared.

As a raw material for the above-mentioned polyimide resin, polyamic acid; and diamine and a tetracarboxylic dianhydride which are raw materials for polyamic acid, and the like, are preferable. Aromatic polyamic acid; and aromatic diamine and tetracarboxylic dianhydride, are preferable. An alicyclic polyimide resin is also preferable as the polyimide resin. Diamine and an alicyclic tetracarboxylic dianhydride are preferably used as a raw material for the alicyclic polyimide.

The above-mentioned polyamic acid is not especially limited as long as it can become polyimide by heating and the like. Various polyamic acids may be used. For example, a common polyamic acid having a constitutional unit (3) represented by the following formula may be mentioned.

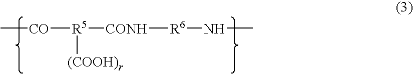

in the formula, R⁵ representing a trivalent or tetravalent organic group containing at least two carbon atoms; R⁶ being a divalent organic group containing at least two carbon atoms; and r being the number of 1 to 2.

It is preferable that R⁵ contains a cyclic hydrocarbon, an aromatic ring, or an aromatic heterocycle in terms of heat resistance. More preferably, R⁵ is a trivalent or tetravalent group containing a cyclic hydrocarbon, an aromatic ring, or an aromatic heterocycle, and 6 to 30 carbon atoms. R⁵ is not especially limited and various organic groups may be used. Examples of R⁵ include a phenyl group, a biphenyl group, a terphenyl group, a naphthalene group, a perylene group, a diphenyl ether group, a diphenylsulfone group, a diphenyl propane group, a benzophenone group, a biphenyl trifluoropropane group, a cyclobutyl group, and a cyclopentylic group.

It is preferable that R⁶ contains a cyclic hydrocarbon, an aromatic ring, or an aromatic heterocycle in terms of heat resistance. More preferably, R⁶ is a divalent group containing a cyclic hydrocarbon, an aromatic ring, or an aromatic heterocycle and 6 to 30 carbon atoms. R⁶ is not especially limited and various organic groups can be used. Examples of R⁶ include a phenyl group, a biphenyl group, a terphenyl group, a naphthalene group, a perylene group, a diphenyl ether group, a diphenylsulfone group, a diphenyl propane group, a benzophenone group, a biphenyl trifluoropropane group, a diphenylmethane group, and a dicyclohexyl methane group.

In the above-mentioned polyamic acid having the constitutional unit (3) as a main component, each of R⁵ and R⁶ may be composed of one compound or two or more different compounds.

As the above-mentioned polyamic acid having the constitutional unit (3) as a main component, polyamic acids (polyimide precursors) produced using one or more carboxylic dianhydrides and one or more diamines. The one or more carboxylic dianhydrides are selected from the group consisting of pyromellitic dianhydride, 3,3′,4,4′-benzophenone tetracarboxylic dianhydride, 3,3′,4,4′-biphenyl trifluoropropane tetracarboxylic dianhydride, 3,3′,4,4′-biphenyl sulfone tetracarboxylic dianhydride, and 2,3,5-tricarboxycyclopentyl acetic dianhydride. The one or more diamines are selected from the group consisting of p-phenylenediamine, 3,3-diaminodiphenyl ether, 4,4′-diaminodiphenyl ether, 3,4′ diaminodiphenyl ether, 3,3′-diaminodiphenylsulfone, 4,4′-diaminodiphenylsulfone, 4,4′-diaminodicyclohexylmethane, and 4,4′-diaminodiphenylmethane. The polyamic acid is not limited thereto, and the polyamic acid may be produced using compounds other than the exemplified carboxylic dianhydrides and diamines. The tetracarboxylic dianhydride and the diamine are selectively combined and reacted with each other in a solvent, and thereby the above-mentioned polyamic acid can be produced.

The raw material for the thermosetting polyimide is preferably an aromatic diamine.

Specific examples of the above-mentioned aromatic diamine include p-phenylenediamine (PPD), meta-phenylenediamine (MPDA), 2,5-diaminotoluene, 2,6-diaminotoluene, 4,4′-diaminobiphenyl, 3,3′-dimethyl-4,4′-biphenyl, 3,3′-dimethoxy-4,4′-biphenyl, 2,2-bis(trifluoromethyl)-4,4′-diaminobiphenyl, 4,4′-bis(3-aminophenoxy)biphenyl, 3,3′-diaminodiphenylmethane, 4,4′-diaminodiphenylmethane (MDA), 2,2-bis-(4-aminophenyl)propane, 3,3′-diaminodiphenylsulfone (33DDS), 4,4′-diaminodiphenylsulfone (44DDS), 3,3′-diaminodiphenyl sulfide, 4,4′-diaminodiphenyl sulfide, 3,3′-diaminodiphenyl ether, 3,4′-diaminodiphenyl ether (34ODA), 4,4′-diaminodiphenyl ether (ODA), 1,5-diaminonaphthalene, 4,4′-diaminodiphenyl diethylsilane, 4,4′-diaminodiphenyl silane, 4,4′-diaminodiphenylethyl phosphine oxide, 1,3-bis(3-aminophenoxy)benzene (133APB), 1,3-bis(4-aminophenoxy)benzene (134APB), 1,4-bis(4-aminophenoxy)benzene, bis[4-(3-aminophenoxy) phenyl]sulfone (BAPSM), bis[4-(4-aminophenoxy)phenyl]sulfone (BAPS), 2,2-bis[4-(4-aminophenoxy) phenyl]propane (BAPP), 2,2-bis(3-aminophenyl)1,1,1,3,3,3-hexafluoropropane, 2,2-bis(4-aminophenyl)1,1,1,3,3,3-hexafluoropropane, and 9,9-bis(4-aminophenyl)fluorene, 3,3′-dichlorobenzidine, 1,5-diaminonaphthalene, 3,3′-dimethyl-4,4′-biphenyldiamine, benzidine, 3,3′-dimethylbenzidine, 3,3′-dimethoxybenzidine, 4,4′-diaminodiphenyl propane, 2,4-bis(β-amino-t-butyl)toluene, bis(p-β-amino-t-buthylphenyl)ether, bis(p-β-methyl-δ-aminophenyl)benzene, bis-p-(1,1-dimethyl-5-amino-pentyl)benzene, 1-isopropyl-2,4-m-phenylenediamine, m-xylylene diamine, and p-xylylene diamine. Among these, preferable examples of the diamine include p-phenylenediamine (PPD), meta-phenylenediamine (MPDA), 4,4′-diaminodiphenylmethane (MDA), 3,3′-diaminodiphenylsulfone (33DDS), 4,4′-diaminodiphenylsulfone (44DDS), 3,4′-diaminodiphenyl ether (34ODA), 4,4′-diaminodiphenyl ether (ODA), 1,3-bis(3-aminophenoxy)benzene (133APB), 1,3-bis(4-aminophenoxy)benzene (134APB), bis[4-(3-aminophenoxy)phenyl]sulfone (BAPSM), bis[4-(4-aminophenoxy) phenyl]sulfone (BAPS), and 2,2-bis[4-(4-aminophenoxy) phenyl]propane (BAPP).

Diamines other than the aromatic diamines may be used. Examples of diamines other than the aromatic diamines include di(p-aminocyclohexyl)methane, hexamethylenediamine, heptamethylene diamine, octamethylene diamine, nonamethylene diamine, decamethylene diamine, diaminopropyltetramethylene, and 3-methyl heptamethylene diamine, 4,4-dimethyl heptamethylene diamine, 2,11-diaminododecane, 1,2-bis-3-aminopropoxy ethane, 2,2-dimethylpropylenediamine, 3-methoxy hexamethylenediamine, 2,5-dimethyl heptamethylene diamine, 5-methyl nonamethylene diamine, 2,17-diaminoeicosa decane, 1,4-diaminocyclohexane, 1,10-diamino-1,10-dimethyldecane, 1,12-diaminooctadecane, piperazine, H₂N(CH₂)₃O(CH₂)₂OCH₂NH₂, H₂N(CH₂)₃S(CH₂)₃NH₂, and H₂N(CH₂)₃N(CH₂)₂ (CH₂)₃NH₂.

Aromatic tetracarboxylic dianhydrides are preferable as the above-mentioned tetracarboxylic dianhydride that is a raw material for the thermosetting polyimide resin. Specific examples of the aromatic tetracarboxylic dianhydrides include pyromellitic dianhydride (PMDA), 1,2,5,6-naphthalene tetracarboxylic dianhydride, 1,4,5,8-naphthalene tetracarboxylic dianhydride, 2,3,6,7-naphthalene tetracarboxylic dianhydride, 2,2′,3,3′-biphenyl tetracarboxylic dianhydride, 2,3,3′,4′-biphenyl tetracarboxylic dianhydride, 3,3′,4,4′-biphenyl tetracarboxylic dianhydride (BPDA), 2,2′,3,3′-benzophenone tetracarboxylic dianhydride, 2,3,3′,4′-benzophenone tetracarboxylic dianhydride, 3,3′,4,4′-benzophenone tetracarboxylic dianhydride (BTDA), bis(3,4-dicarboxyphenyl)sulfone dianhydride, bis(2,3-dicarboxyphenyl)methane dianhydride bis(3,4-dicarboxyphenyl)methane dianhydride, 1,1-bis(2,3-dicarboxyphenyl)ethane dianhydride, 1,1-bis(3,4-dicarboxyphenyl)ethane dianhydride, 2,2-bis[3,4-(dicarboxyphenoxy)phenyl]propane dianhydride (BPADA), 4,4′-(hexafluoro isopropylidene)diphthalic anhydride, oxydiphthalic anhydride (ODPA), bis(3,4-dicarboxyphenyl)sulfone dianhydride, bis(3,4-dicarboxyphenyl)sulfoxide dianhydride, thiodiphthalic dianhydride, 3,4,9,10-perylenetetracarboxylic dianhydride, 2,3,6,7-anthracenetetracarboxylic dianhydride, 1,2,7,8-phenanthrenetetracarboxylic dianhydride, 9,9-bis(3,4-dicarboxyphenyl)fluorine dianhydride, and 9,9-bis[4-(3,4′-dicarboxyphenoxy)phenyl]fluorene dianhydride. Among these, preferable examples of the tetracarboxylic dianhydrides include pyromellitic dianhydride (PMDA), 3,3′,4,4′-biphenyl tetracarboxylic dianhydride (BPDA), 3,3′,4,4′-benzophenone tetracarboxylic dianhydride (BTDA), 2,2-bis[3,4-(dicarboxyphenoxy)phenyl]propane dianhydride (BPADA), oxydiphthalic anhydride (ODPA), 2,3,3′,4-biphenyl tetracarboxylic dianhydride, 2,2′-bis(3,4-dicarboxyphenyl)propane dianhydride, perylene-3,4,9,10-tetracarboxylic dianhydride, bis(3,4-dicarboxyphenyl)ether dianhydride, and ethylene tetracarboxylic dianhydride. They may be reacted with an alcohol such as methanol and ethanol to form ester compounds. These aromatic diamines, aromatic tetracarboxylic acids, and anhydrides of aromatic tetracarboxylic acids may be used singly or mixed. Further, a plurality of polyimide precursor solutions can be prepared, and those polyimide precursor solutions can also be mixed and used.

The following compounds are mentioned as an organic polar solvent used when the above-mentioned aromatic tetracarboxylic acid (or aromatic tetracarboxylic dianhydride) is reacted with the aromatic diamine. N,N-dimethylformamide, N,N-dimethylacetamide, N,N-diethyl acetamide, N-methyl-2-pyrrolidone, 1,3-dimethyl-2-imidazolidinone, N-methylcaprolactam, hexamethylphosphoric triamide, 1,2-dimethoxyethane, diglyme, and triglyme. Among these, preferable solvents are N,N-dimethylacetamide (DMAc) and N-methyl-2-pyrrolidone (NMP). These solvents may be used singly or as a mixture, or may be used in combination with other solvents, e.g., aromatic hydrocarbons such as toluene and xylene.

The thermoplastic polyimide resin is mentioned below.

A thermoplastic polyimide resin obtainable by a polycondensation reaction of a raw material composition containing a diamine component and a tetracarboxylic dianhydride component is preferable as the thermoplastic polyimide resin. It is preferable that the thermoplastic polyimide resin has a glass transition temperature Tg of 100 to 300° C.

The diamine used as a raw material for the thermoplastic polyimide resin is not especially limited as long as 4,4′-bis(3-aminophenoxy)biphenyl and the like may be used as mentioned above. Various raw materials can be used unless the effects of the present invention are sacrificed. The diamine which can be used as a raw material for the thermoplastic polyimide resin are exemplified below.

Examples of the diamine which can be used as a raw material for the thermoplastic polyimide resin include m-phenylenediamine, o-phenylenediamine, p-phenylenediamine, m-aminobenzylamine, p-aminobenzylamine, 4,4′-diaminodiphenyl ether, 3,3′-diaminodiphenylether, 3,4′-diaminodiphenylether, bis(3-aminophenyl)sulfide, bis(4-aminophenyl)sulfide, (3-aminophenyl) (4-aminophenyl)sulfide, bis(3-aminophenyl)sulfoxide, bis(4-aminophenyl)sulfoxide, (3-aminophenyl) (4-aminophenyl) sulfoxide, bis(3-aminophenyl)sulfone, bis(4-aminophenyl)sulfone, (3-aminophenyl)(4-aminophenyl)sulfone, 3,3′-diaminobenzophenone, 4,4′-diaminobenzophenone, 3,4′-diaminobenzophenone, 3,3′-diaminodiphenylmethane, 4,4′-diaminodiphenylmethane, 3,4′-diaminodiphenylmethane, bis[4-(3-aminophenoxy)phenyl]methane, bis[4-(4-aminophenoxy)phenyl]methane, 1,1-bis[4-(3-aminophenoxy)phenyl]ethane, 1,2-bis[4-(3-aminophenoxy)phenyl]ethane, 1,1-bis[4-(4-aminophenoxy)phenyl]ethane, 1,2-bis[4-(4-aminophenoxy)phenyl]ethane, 2,2-bis[4-(3-aminophenoxy)phenyl]propane, 2,2-bis[4-(4-aminophenoxy)phenyl]propane, 2,2-bis[4-(3-aminophenoxy)phenyl]butane, 2,2-bis[3-(3-aminophenoxy)phenyl]-1,1,1,3,3,3-hexafluoropropane, 2,2-bis[4-(4-aminophenoxy)phenyl]-1,1,1,3,3,3-hexafluoropropane, 1,3-bis(3-aminophenoxy)benzene, 1,3-bis(4-aminophenoxy)benzene, 1,4-bis(3-aminophenoxy)benzene, 1,4-bis(4-aminophenoxy)benzene, 4,4′-bis(4-aminophenoxy)biphenyl, bis[4-(3-aminophenoxy)phenyl]ketone, bis[4-(4-aminophenoxy)phenyl]ketone, bis[4-(3-aminophenoxy)phenyl]sulfide, bis[4-(4-aminophenoxy)phenyl]sulfide, bis[4-(3-aminophenoxy)phenyl]sulfoxide, bis[4-(4-aminophenoxy)phenyl]sulfoxide, bis[4-(3-aminophenoxy)phenyl]sulfone, bis[4-(4-aminophenoxy)phenyl]sulfone, bis[4-(3-aminophenoxy)phenyl]ether, bis[4-(4-aminophenoxy)phenyl]ether, 1,4-bis[4-(3-aminophenoxy)benzoyl]benzene, 1,3-bis[4-(3-aminophenoxy)benzoyl]benzene, 4,4′-bis[3-(4-aminophenoxy)benzoyl]diphenyl ether, 4,4′-bis[3-(3-aminophenoxy)benzoyl]diphenyl ether, 4,4′-bis[4-(4-amino-α,α-dimethylbenzyl)phenoxy]benzophenone, 4,4′-bis[4-(4-amino-α,α-dimethylbenzyl)phenoxy]diphenylsulfone, bis[4-{4-(4-aminophenoxy)phenoxy}phenyl]sulfone, 1,4-bis[4-(4-aminophenoxy)phenoxy-α,α-dimethylbenzyl]benzene, 1,3-bis[4-(4-aminophenoxy)phenoxy-α,α-dimethylbenzyl]benzene, 1,3-bis[4-(4-amino-6-trifluoromethylphenoxy)-α,α-dimethyl benzyl]benzene, 1,3-bis[4-(4-amino-6-fluorophenoxy)-α,α-dimethylbenzyl]benzene, 1,3-bis[4-(4-amino-6-methylphenoxy)-α,α-dimethylbenzyl]benzene, 1,3-bis[4-(4-amino-6-cyanophenoxy)-α,α-dimethylbenzyl]benzene, 3,3′-diamino-4,4′-diphenoxybenzophenone, 4,4′-diamino-5,5′-diphenoxybenzophenone, 3,4′-diamino-4,5′-diphenoxybenzophenone, 3,3′-diamino-4-phenoxybenzophenone, 4,4′-diamino-5-phenoxybenzophenone, 3,4′-diamino-4-phenoxybenzophenone, 3,4′-diamino-5′-phenoxybenzophenone, 3,3′-diamino-4,4′-dibiphenoxybenzophenone, 4,4′-diamino-5,5′-dibiphenoxybenzophenone, 3,4′-diamino-4,5′-dibiphenoxybenzophenone, 3,3′-diamino-4-biphenoxybenzophenone, 4,4′-diamino-5-biphenoxybenzophenone, 3,4′-diamino-4-biphenoxybenzophenone, 3,4′-diamino-5′-biphenoxybenzophenone, 1,3-bis(3-amino-4-phenoxybenzoyl)benzene, 1,4-bis(3-amino-4-phenoxybenzoyl)benzene, 1,3-bis(4-amino-5-phenoxybenzoyl)benzene, 1,4-bis(4-amino-5-phenoxybenzoyl)benzene, 1,3-bis(3-amino-4-biphenoxy benzoyl)benzene, 1,4-bis(3-amino-4-biphenoxy benzoyl)benzene, 1,3-bis(4-amino-5-biphenoxy benzoyl)benzene, 1,4-bis(4-amino-5-biphenoxy benzoyl)benzene, 2,6-bis[4-(4-amino-α,α-dimethylbenzyl)phenoxy]benzonitrile, 6,6′-bis(2-aminophenoxy)-3,3,3′,3′-tetramethyl 1,1′-spirobiindan, 6,6′-bis(3-aminophenoxy)-3,3,3′,3′-tetramethyl 1,1′-spirobiindan, 4,4′-bis(3-aminophenoxy)biphenyl, 1,3-bis(3-(3-aminophenoxy)phenoxy)benzene, bis(3-(3-aminophenoxy)phenyl)ether, bis(3-(3-(3-aminophenoxy)phenoxy)phenyl)ether, bis(4-(3-aminophenoxy)phenyl)sulfone, 1,3-bis(4-(4-aminophenoxy)-α,α-dimethylbenzyl)benzene, 2,2-bis(4-aminophenoxyphenyl)propane, 1,3-bis(1-(4-(4-aminophenoxy)phenyl)-1-methylethyl)benzene, 1,4-bis(1-(4-(4-aminophenoxy)phenyl)-1-methylethyl)benzene, 1,4-bis(1-(4-(3-aminophenoxy)phenyl)-1-methylethyl)benzene, 2,2-bis(3-(3-aminophenoxy)phenyl)-1,1,1,3,3,3-hexafluoropropane, and 2,2-bis(3-(4-aminophenoxy)phenyl)-1,1,1,3,3,3-hexafluoropropane. More preferably, at least one diamine selected from the group consisting of 1,3-bis(3-aminophenoxy)benzene, 4,4′-bis(3-aminophenoxy)biphenyl, and 1,3-bis(3-(3-aminophenoxy)phenoxy)benzene is used. 1,3-bis(3-aminophenoxy)benzene and 1,3-bis(3-(3-aminophenoxy)phenoxy)benzene are still more preferable diamines. They may be used singly or as a mixture of two or more species of them.

The above-mentioned tetracarboxylic dianhydride used as a raw material for thermoplastic polyimide is not especially limited as long as it can generate a thermoplastic polyimide. The following tetracarboxlic dianhydrides can be used, for example.

3,3′,4,4′-benzophenone tetracarboxylic dianhydride, pyromellitic dianhydride, 3,3′,4,4′-biphenyl tetracarboxylic dianhydride, oxy-4,4′-diphthalic dianhydride, 2,2-bis[4-(3,4-dicarboxyphenoxy)phenyl]propane dianhydride, ethylene glycol bistrimellitic dianhydride, 2,2-bis(3,4-dicarboxyphenyl)-1,1,1,3,3,3-hexafluoropropane dianhydride, 2,2′,3,3′-benzophenone tetracarboxylic dianhydride, 1,2-bis(3,4-dicarboxybenzoyl)benzene dianhydride, 1,3-bis(3,4-dicarboxybenzoyl)benzene dianhydride, 1,4-bis(3,4-dicarboxybenzoyl)benzene dianhydride, 2,2′-bis((3,4-dicarboxy)phenoxy)benzophenone dianhydride, 2,3′-bis((3,4-dicarboxy) phenoxy)benzophenone dianhydride, 2,4′-bis((3,4-dicarboxy)phenoxy)benzophenone dianhydride, 3,3′-bis((3,4-dicarboxy)phenoxy)benzophenone dianhydride, 3,4′-bis((3,4-dicarboxy)phenoxy)benzophenone dianhydride, and 4,4′-bis((3,4-dicarboxy)phenoxy)benzophenone dianhydride.

The above-mentioned thermoplastic polyimide resin can be produced using the above-mentioned raw material. The raw material for the thermoplastic polyimide is not especially limited as long as the thermoplastic polyimide resin is produced. Various compounds can be used. The preferable embodiments include an embodiment in which the thermoplastic polyimide resin has a constitutional unit represented by the following formula.

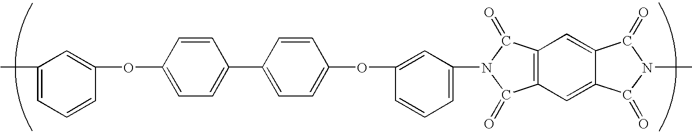

Examples of the raw material monomer for producing this thermoplastic polyimide resin include: a ring-opened compound prepared by hydrolysis of 4,4′-bis(3-aminophenoxy) biphenyl, pyromellitic dianhydride, or at least part thereof; and a ring-opened compound by hydrolysis of phthalic anhydride or at least part thereof.

An alicyclic polyimide resin can be used as the above-mentioned polyimide resin, in addition to the aromatic polyimide resin. The raw material for generating the alicyclic polyimide resin is not especially limited. For example, the following alicyclic tetracarboxylic dianhydride can be used as the raw material. Preferable examples of the alicyclic tetracarboxylic dianhydride include monocyclic aliphatic tetracarboxylic dianhydride represented by the following formula:

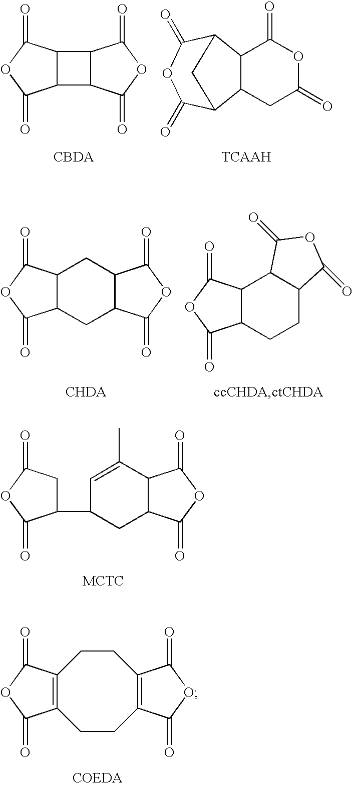

aliphatic tetracarboxylic dianhydride having a bicyclo ring structure, represented by the following formula:

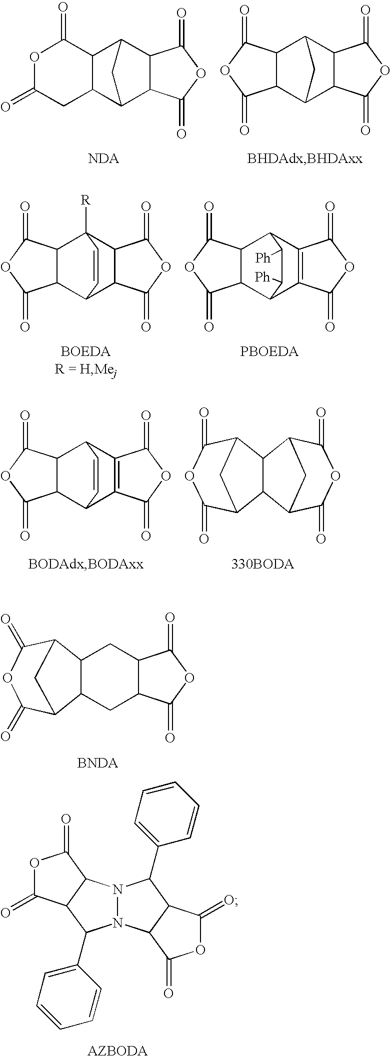

and tetracarboxylic dianhydride having a polycycloaliphatic structure containing three or more rings, represented by the following formula.

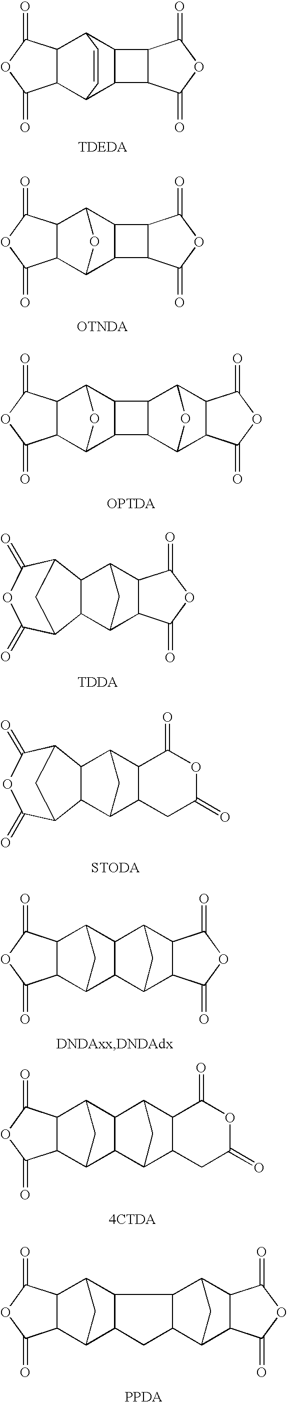

The above-mentioned thermoplastic polyimide resin can be produced by a publicly known method. For example, a raw material composition is obtained by mixing the above-mentioned tetracarboxylic dianhydride component with the above-mentioned diamine component at a specific ratio in a solvent such as N-methyl-2-pyrrolidone (NMP), dimethylformamide (DMF), N,N-dimethylacetamide (DMAc), dimethyl sulfoxide (DMSO), dimethyl sulfate, sulfolane, butyrolactone, cresol, phenol, halogenated phenol, cyclohexane, dioxane, tetrahydrofuran, diglyme, and triglyme. The obtained raw material composition is subjected to a reaction at a temperature within 0 to 100° C., thereby forming a solution of a thermoplastic polyimide precursor. Polyamic acid is mentioned as the polyimide precursor, for example. An imidated product is obtained by heating this solution in a high temperature atmosphere at 200 to 500° C. As a result, a solution of a thermoplastic polyimide can be obtained.

The molar ratio of the diamine component to the tetracarboxylic dianhydride component each contained in the raw material for the thermoplastic polyimide (tetracarboxylic acid dianhydride component/diamine component) is preferably 0.75 to 1.25 and more preferably 0.90 to 1.10 and particularly preferably 1.00 to 0.97. If the molar ratio is within such a range, the reaction can be easily controlled and the produced thermoplastic polyimide shows excellent fluidity when it is heated. The total content of the diamine component and the tetracarboxylic dianhydride component in the raw material composition contained in the thermoplastic polyimide precursor solution is preferably 5 to 20% by weight.

The compound having a polymerizable unsaturated bond is mentioned below as one of the preferable embodiments of the organic resin raw material of the present invention.

The above-mentioned compound having a polymerizable unsaturated bond is sufficient as long as it has a polymerizable unsaturated bond. Such a compound having a polymerizable unsaturated bond is preferably a compound containing at least one group selected from the group consisting of a (meth)acryloyl group, a vinyl group, a fumarate group, and a maleimide group. That is, it is preferable that the compound having a polymerizable unsaturated bond is at least one compound selected from the group consisting of a (meth)acryloyl group-containing compound, a vinyl group-containing compound, a fumarate group-containing compound, and a maleimide group-containing compound. In the present invention, the (meth)acryloyl group means an acryloyl group or a methacryloyl group. If the compound contains an acryloyl group, the acryloyl group contains a vinyl group. However, in this case, the compound is not regarded as a compound containing both of an acyloyl group and a vinyl group but as a compound containing an acryloyl group. The fumarate group means a group having a fumarate structure, that is, a fumaric acid ester structure.

If the organic resin raw material of the present invention contains a polyphenol compound, the organic resin raw material is thermally cured using a curing agent to become a cured product. A compound containing at least two epoxy groups may be mentioned as the above-mentioned curing agent. As the above-mentioned compound containing at least two epoxy groups, an epoxy resin containing an average of two or more epoxy groups in one molecule is preferable. Preferable examples of such an epoxy resin are mentioned below. Epibis glycidyl ether epoxy resins obtained by condensation reaction of epihalohydrin with a bisphenol such as bisphenol A, bisphenol F, and bisphenol S, novolac aralkyl glycidyl ether epoxy resins obtained by a condensation reaction of epihalohydrin with polyphenol obtained by a condensation reaction of a phenol such as phenol, cresol, xylenol, resorcin, catechol, bisphenol. A, and bisphenol F with formaldehyde, acetoaldehyde, propionaldehyde, benzaldehyde, salicylaldehyde, dicyclopentadiene, terpene, coumarin, paraxylylene dimethyl ether, or dichroloparaxylene; glycidyl ether epoxy resins obtained by a condensation reaction of epihalohydrin with tetrahydrophthalic acid, hexahydrophthalic acid, or benzoic acid; glycidyl ether epoxy resins obtained by a condensation reaction of epihalohydrin with hydrogenated bisphenol or glycol; amine-containing glycidyl ether epoxy resins obtained by a condensation reaction of epihalohydrin with hydantoin or cyanuric acid; and aromatic polycyclic epoxy resins such as a bisphenyl epoxy resin and a naphthalene epoxy resin. Further, compounds containing an epoxy group in the molecule, by addition reaction of these epoxy resins with a polybasic acid and/or a bisphenol. One or more species of them may be used.

The ratio by weight of the above-mentioned polyphenol compound with the above-mentioned epoxy resin curing agent (polyphenol compound/epoxy resin curing agent) is preferably 30/70 or more and 70/30 or less. If the ratio by weight is less than 30/70, mechanical properties and the like of the obtained cured product might be reduced. If the ratio by weight is more than 70/30, the flame retardancy might be insufficient. The ratio by weight is more preferably 35/65 or more and 65/35 or less. A curing accelerator may be used for the above-mentioned curing. Preferable examples of the above-mentioned curing accelerator include: imidazoles such as 2-methylimidazole and 2-ethyl-4-methylimidazole; amines such as 2,4,6-tris(dimethyl aminomethyl)phenol, benzyl methylamine, DBU (1,8-diazabicyclo[5.4.0]-7-undecene), and DCMU (3-(3,4-dichlorophenyl)-1,1-dimethylurea); and organic phosphorus compounds such as tributyl phosphine, triphenyl phosphine, and tris(dimethoxy phenyl)phosphine.

It is preferable that the light-shielding resin composition of the present invention contains a surface adjustor in addition to the above-mentioned organic resin raw material. The above-mentioned surface adjustor is used to improve uniformity of the film of the light-shielding layer. Specifically, such a surface adjustor can be preferably used to suppress generation of a void or an orange peel-like surface. A compound having a high surface tension-reducing ability is preferable as the surface adjustor because such a compound shows a high effect of suppressing generation of the void. Further, a compound having a high polarity is preferable because such a compound shows a high effect of suppressing generation of the orange peel-like surface. A silicone surface adjustor (silicone additive) is preferable as the surface adjustor, for example. Examples of the silicone surface adjustor include products of BYK-Chemie-Japan-KK., BYK-300, BYK-301, BYK-302, BYK-306, BYK-307, BYK-310, BYK-315, BYK-320, BYK-322, BYK-323, BYK-325, BYK-330, BYK-331, BYK-333, BYK-337, BYK-341, BYK-344, BYK-345, BYK-346, BYK-347, BYK-348, BYK-349, BYK-370, BYK-375, BYK-377, BYK-378, BYK-UV3500, BYK-UV3510, and BYK-UV3570. Among these, BYK-306, BYK-310, BYK-333, BYK-370, and BYK-375 are preferable because of a high polarity. In view of a high surface tension-reducing ability, BYK-306, BYK-307, BYK-330, BYK-333, BYK-370, BYK-377, BYK-341, and BYK-375 are preferable. In view of a high polarity and a high surface tension-reducing ability, BYK-306, BYK-333, and BYK-375 are particularly preferable.

The light-shielding resin composition of the present invention may contain, in addition to the above-mentioned black material, organic resin raw material and surface adjustor, and the like, a curing accelerator, a reactive diluent, a saturated compound having no unsaturated bond, a pigment, a dye, an antioxidant, an ultraviolet absorber, a light stabilizer, a plasticizer, a non-reactive compound, a chain transfer agent, a thermal polymerization initiator, an anaerobic polymerization initiator, a polymerization inhibitor, an inorganic or organic filler, an agent for improving adhesion such as a coupling agent, a thermostabilizer, an antibacterial and antifungal agent, a flame retarder, a delustering agent, a defoaming agent, a leveling agent, a wetting and dispersing agent, an antisettling agent, a thickener and an antisagging agent, a color separation inhibitor, an emulsifier, a slip and scrape proofing agent, an antiskinning agent, a drying agent, a stain proofing agent, an antistatic agent, and a conductive agent (electrostatic assistant).

### EFFECT OF THE INVENTION

The present invention has the above-mentioned configuration. The present invention is a light-shielding film excellent in light-shielding property and heat resistance, a production method of such a film, and a lens unit including such a film. This lens unit is preferably used in an opto device application, a display device application, and various other applications such as a mechanical component, and an electrical and electronic component.

### BRIEF DESCRIPTION OF DRAWINGS

FIG. 1 is a cross-sectional view of the light-shielding film and shows the case where the line roughness (Ra) of the light-shielding film of the present invention is determined.

FIG. 2 is a cross-sectional view of the light-shielding film and shows the case where the maximum height (Ry) of the light-shielding film of the present invention is determined.

FIG. 3 is a cross-sectional view of the light-shielding film and shows the case where the ten point height of roughness (Rz) of the light-shielding film of the present invention is determined.

FIG. 4 is a cross-sectional view of the light-shielding film and shows the case where the mean spacing (S) of local peaks of the light-shielding film of the present invention is determined.

FIG. 5 is a cross-sectional view of the light-shielding film in accordance with one preferable embodiment of the present invention.

FIG. 6 is a cross-sectional view schematically showing a configuration of the camera module in accordance with one preferable embodiment of the lens unit in the present invention.

FIG. 7 is a cross-sectional view of a lens unit of the present invention and shows a relationship between the light-shielding film and the lens.

FIG. 8 shows a planar view schematically showing the light-shielding film in accordance with one preferable embodiment, of the lens unit in the present invention.

FIG. 9 is a planar view schematically showing the light-shielding film in accordance with one preferable embodiment, of the lens unit in the present invention.

FIG. 10 is a schematic view showing an extension of the back focus, depending on the existence of the light-shielding film.

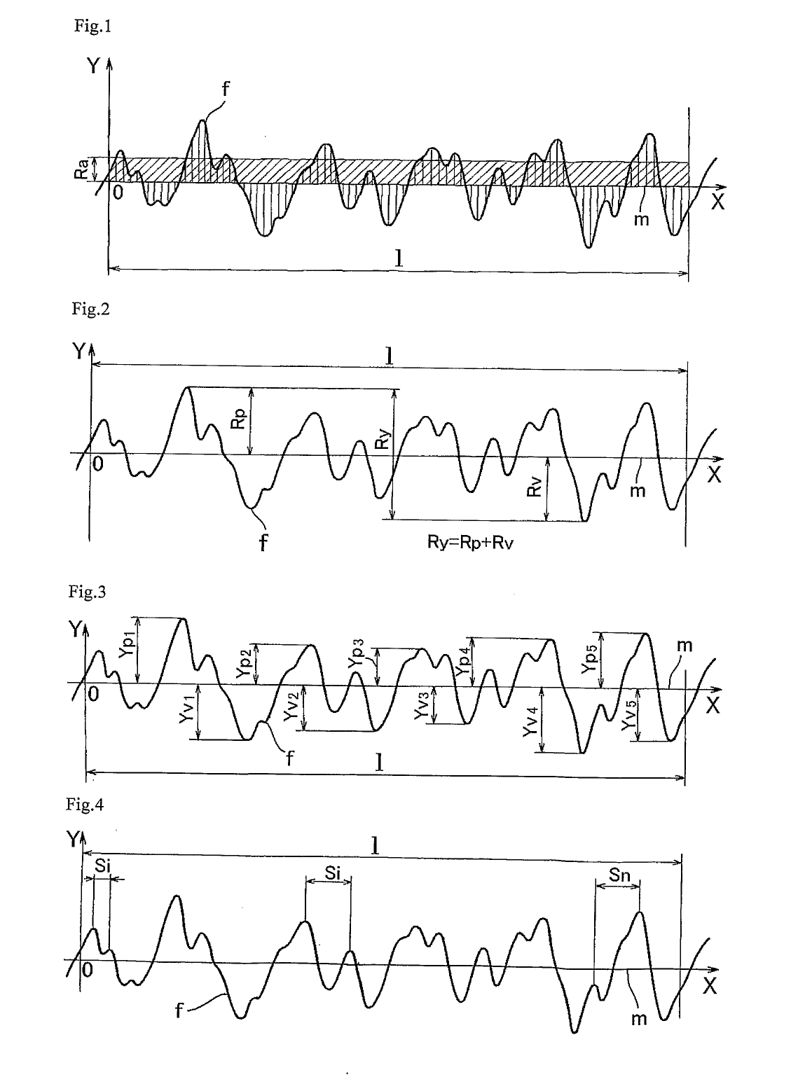

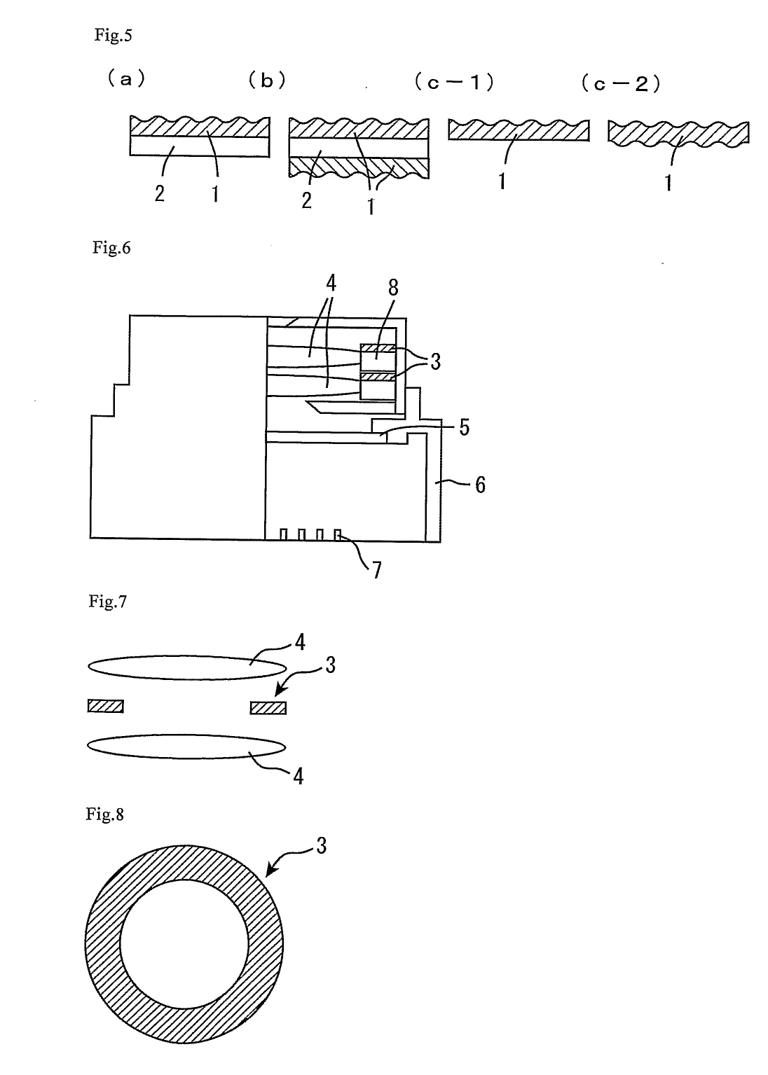

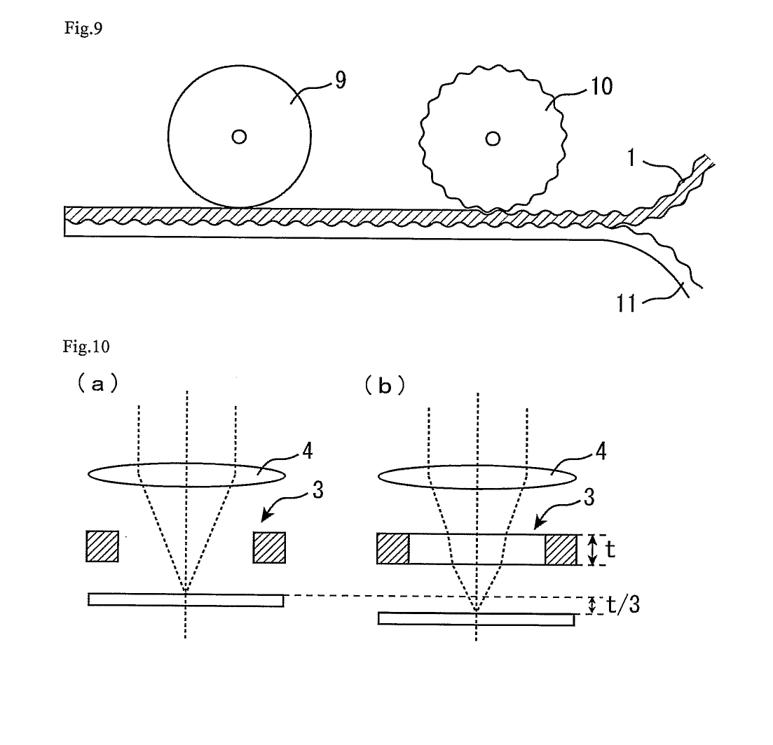

### EXPLANATION OF NUMERALS AND SYMBOLS

1: Light-shielding layer
2: Base material
3: Light-shielding film
4: Lens
5: Infrared-cutting filter
6: Barrel
7: Sensor lens
8: Edge
9: Roll
10: Matte Roll transfer layer
11: Transfer Layer
f: Roughness curve
m: Average line

### BEST MODES FOR CARRYING OUT THE INVENTION

The present invention is mentioned in more detail below with reference to Examples, but the present invention is not limited to these Examples. The terms “part (s)” and “%” represent “part (s) by weight” and “% by weight”, respectively, unless otherwise specified.

### Synthesis Example 1

### Production of FPEK

Into a reactor equipped with a thermometer, a cooling tube, a gas inlet tube, and a stirrer, BPDE (4,4′-bis(2,3,4,5,6-pentafluorobenzoyl)diphenylether) 16.74 parts, HF (9,9-bis(4-hydroxyphenyl)fluorene) 10.5 parts, potassium carbonate 4.34 parts, DMAc (N,N-dimethylacetamide) 90 parts were charged. This mixture was heated to 60° C. and the reaction was allowed to proceed for 8 hours. After completion of the reaction, the reaction solution was added into distilled water under agitation with a blender. The precipitated reactant was separated by filtration. The solid substance obtained by the filtration was washed with distilled water and methanol and then, dried under reduced pressure. As a result, a polymer A was obtained. The reaction formula is shown below. The polymer A is an fluorinated aromatic polyether ketone resin having a repeating unit, obtained by the reaction shown in the following reaction formula. The polymer A had a Tg of 242° C. and a number average molecular weight (Mn) of 55322.

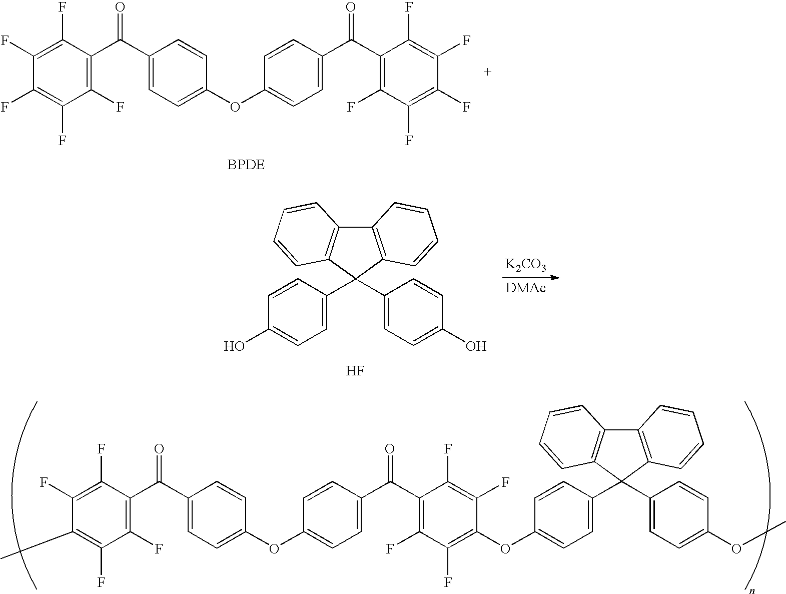

### Synthesis Example 2

### Production of FPEK

Into a reactor equipped with a thermometer, a cooling tube, a gas inlet tube, and a stirrer, BPDE (4,4′-bis(2,3,4,5,6-pentafluorobenzoyl)diphenylether) 15.15 parts, Bis-AF (2,2-bis(4-hydroxyphenyl)hexafluoropropane) 9.08 parts, potassium carbonate 5.97 parts, DMAc (N,N-dimethylacetamide) 90 parts were charged. This mixture was heated to 60° C. and the reaction was allowed to proceed for B hours. After completion of the reaction, the reaction solution was added into distilled water under agitation with a blender. The precipitated reactant was separated by filtration. The solid substance obtained by the filtration was washed with distilled water and methanol and then, dried under reduced pressure. As a result, a polymer B was obtained. The reaction formula is shown below. The polymer B is an fluorinated aromatic polyether ketone resin having a repeating unit, obtained by the reaction shown in the following reaction formula. The polymer B had a Tg of 193° C. and a number average molecular weight (Mn) of 53786.

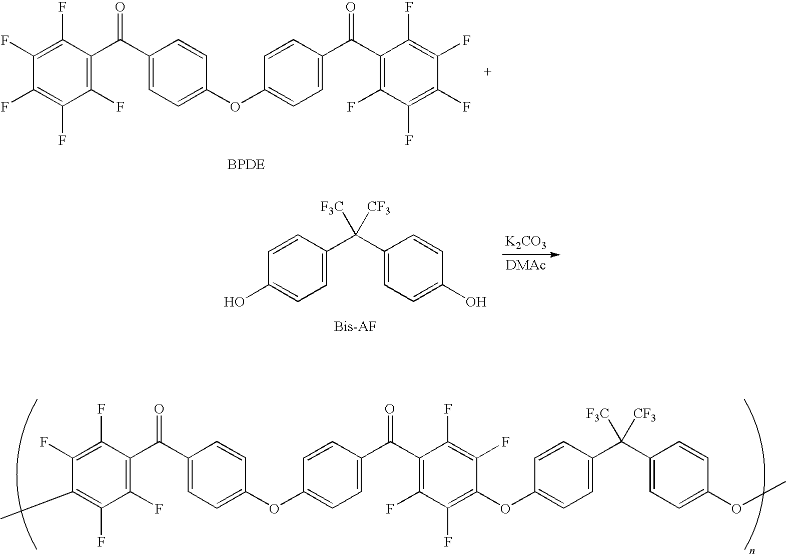

### “Preparation of Polymer A Containing Black Fine Particles”

The above-mentioned polymer A 21.30 parts was dissolved in cyclohexanone 73.37 parts. Thereinto, carbon black HS-100 (product of DENKI KAGAKU KOGYO K.K.) 5.33 parts was added. The mixture was kneaded under the following conditions with a heating type roll mixer. The obtained solution S-A (carbon black-containing polymer A solution) had a solid content of 28.5% by weight. The carbon black-containing polymer A solution is a solution containing black fine particles and the polymer A. The below-mentioned solutions S-C and S-D are also the carbon black-containing polymer A solutions.

### Kneading Conditions:

| | |
|---|---|
| Roll surface temperature | 20° C. |
| Roll pressure | 1 to 3 MPa |
| Kneading time | 10 minutes |

### “Preparation of Polymer B Containing Black Fine Particles”

The above-mentioned polymer B 21.30 parts was dissolved in cyclohexanone 73.37 parts. Thereinto, carbon black HS-100 (product of DENKI KAGAKU KOGYO K.K.) 5.33 parts was added. The mixture was kneaded under the following conditions with a heating type roll mixer. The obtained solution S-B (carbon black-containing polymer B solution) had a solid content of 28.7% by weight.

### Kneading Conditions:

| | |
|---|---|
| Roll surface temperature | 20° C. |
| Roll pressure | 1 to 3 MPa |
| Kneading time | 10 minutes |

### Preparation of Film

### Examples 1 to 7

The above-mentioned solution S-A (the carbon black-containing polymer A solution) was applied on frosted glass that is a base material (Ra=3.575 μm, Ry=51.811 μm, Rz=36.234 μm, S=1.931 μm) to form a film. Thus, a film C having a thickness of 49 μm was obtained by a solvent-casting method in Example 1. In Example 2, the solution S-A was applied on a matte PET film having a thickness of 100 μm, produced by Teijin Dupont Films Japan Ltd. Thus, a film D having a thickness of 50 μm was obtained by a solvent-casting method. Further, also in Example 3, the solution S-A was applied on a matte polyfilm (Ra=0.65 μm, Ry=10.678 μm, Rz=8.851 μm, S=2.211 μm). Thus, a film E having a thickness of 48 μm was obtained by a solvent-casting method. Further, in Example 4, the solution S-A was applied on a matte polyfilm B (Ra=0.65 μm, Ry=11.344 μm, Rz=9.638 μm, and S=2.136 μm). Thus, a film F having a thickness of 49 μm was obtained by a solvent-casting method.

The solvent-casting method and preparation conditions, used for preparing the films C to F, are mentioned below. The solution was applied on the base material and heated at 110° C. for 12 minutes, and then the formed film was separated from the base material. The separated film was further heated at 170° C. for 15 hours. In such a manner, each film was obtained.

The solution S-B (carbon black-containing polymer B solution) was also applied on a matte PET film having a thickness of 100 μm, produced by Teijin Dupont Films Japan Ltd. Thus, a film G having a thickness of 51 μm was obtained by a solvent-casting method. With regard to the preparation of the film G, the conditions of the solvent-casting method, the drying conditions, and the heating conditions were the same as those employed when the films C to F were prepared (the solvent was heated at 110° C. for 12 minutes, and the formed film was separated and the separated film was further heated at 170° C. for 15 hours).

### “Heating Treatment”

Each of the films C and D was sandwiched between frosted glass plates, and then put on a heater and heated at 260° C. for 3 minutes. The heated film C which was taken out of the heater after completion of the heating was defined as a film H that was a heat-treated film in Example 5. The heated film D which was taken out of the heater after completion of the heating was defined as a film I that was a heat-treated film in Example 6.

### Preparation of Film of Cured Product of Curable Resin

### Example 8

EM black (carbon-dispersed epoxy resin, product of Mikuni Color Ltd.) 35.67 parts, YL7217 (flexible epoxy resin, product of Japan Epoxy Resins Co., Ltd.) 15.85 parts, CELLOXIDE 20212 (alicyclic epoxy resin, product of DICEL CHEMICAL INDUSTRIES., LTD.) 47.56 parts, and as a curing accelerator, San-Aid SI-80L (cationic initiator, product of SANSHIN CHEMICAL INDUSTRY CO., LTD.) 0.92 parts were mixed and kneaded under the following conditions using a heating type roll mixer.

### Kneading Conditions:

| | |
|---|---|
| Roll surface temperature | 20° C. |
| Roll pressure | 1 to 3 MPa |
| Kneading time | 5 minutes |

The resin composition obtained after the kneading was applied on a matte PET film having a thickness of 100 μm, produced by Teijin Dupont Films Japan Ltd., with an applicator. Then, the applied composition was cured at 120° C. for 7 minutes and then the cured film was separated. As a result, a film having a thickness of 58 μm was prepared. The film was subjected to post-curing at 170° C. for 5 hours to be further cured. As a result, a film J was obtained. The film J had a Tg of 107° C.

The glass transition temperature, the number average molecular weight, and the content of the solvent of the respective films were measured in the following manners, respectively.

### “Glass Transition Temperature”

The glass transition temperature was measured at a heating rate of 20′C/min using a differential scanning calorimeter (product of Seiko Instruments Inc., DSC220C).

### “Number Average Molecular Weight”

The number average molecular weight was measured by GPO (gel permeation chromatography) on a styrene equivalent basis.

Measuring device: product of TOSOH CORP., HLC-8120GPC

### Column: G-5000HXL+GMHXL-L

Developing solvent: THF
Flow rate: 1 ml/min
Calibration curve: Standard polystyrene was used.

### “Content of Solvent in Film”

The content of the solvent in each film was measured as follows. That is, using a piece of the film as a sample, the sample was measured for a weight reduction amount when the temperature was increased from a normal temperature to 350° C. at a heating speed of 5° C./min, with TG-DTA (product of BRUKER AXS K.K., TG-DTA 2000SA). This weight reduction amount was defined as a content of the solvent. Also in the following Examples, the solvent content in the film was measured by the same method.

### <Evaluation of Physical Properties of Light-Shielding Film>

### “Measurement Method of Glossiness”

The glossiness was measured at a measuring angle (θ) of 60° using a glossimeter VG-2000, produced by Nippon Denshoku Industries Co., Ltd.

### “Measurement Method of Line Roughness (JIS 1994)”

The line roughness was measured and analyzed using the following device and under measurement conditions.

Measuring device: Product of KEYENCE, Color 3D Laser Scanning

### Microscope (VK-9700)

### Measurement Conditions

Object lens: 20 magnification
Zoom: 1.0 magnification
Measurement pitch: RPD
Measurement mode: Surface shape
Measurement region: Plane
Measurement quality: Ultra-high definition
Analysis software: VK-9700/VK-8700
Shape analysis application VK-HIAI
Analysis length (standard length 1): 700 μm

### “Heating Test”

A specimen was prepared by cutting each of the produced films into the following size.

| | |
|---|---|
| Specimen | Film in 40.0 mm × 10.0 mm |
| Test conditions | at 260° C. for 2 minutes (the specimen |
| | was put in a hot air dryer at 260° C. and taken |
| | out 2 minutes later.) |

The above-mentioned specimen was subjected to the heating test as a sample under the above-mentioned conditions. Then, the sample was measured for a change in dimension between before and after the test. Table 1 shows evaluation results of each film.

TABLE 1

| | | Example 1 | Example 2 | Example 3 | Example 4 | Example 5 |
|---|---|---|---|---|---|---|
| Kind of film | | Film C | Film D | Film E | Film F | Film H |
| Thickness of film (μm) | | 49 | 50 | 48 | 49 | 50 |
| Glossiness | | 1.0 | 2.8 | 25.7 | 18.3 | 1.1 |
| JIS1994 | Ra (μm) | 2.187 | 1.312 | 0.914 | 1.038 | 2.235 |
| Line | Ry (μm) | 37.538 | 19.122 | 15.187 | 16.434 | 40.416 |
| roughness | Rz (μm) | 25.628 | 15.783 | 11.947 | 12.785 | 27.526 |
| | S (mm) | 1.832 | 1.942 | 2.122 | 2.056 | 1.883 |
| Film state | Dimension | 40.0 × 10.0 | 40.0 × 10.0 | 40.0 × 10.0 | 40.0 × 10.0 | 40.0 × 10.0 |
| before | (length mm × width mm) | | | | | |
| heating | Thickness (μm) | 49 | 50 | 48 | 48 | 50 |
| test | | | | | | |
| Film state | Dimension | 39.8 × 10.0 | 39.8 × 10.0 | 39.8 × 10.0 | 39.8 × 10.0 | 40.0 × 10.0 |
| after | (length mm × width mm) | | | | | |
| heating | Thickness (μm) | 50 | 51 | 49 | 50 | 50 |
| test | | | | | | |
| | | | | | Comparative | Comparative |
| | | Example 6 | Example 7 | Example 8 | Example 1 | Example 2 |
| Kind of film | | Film I | Film G | Film J | Polyester | Polyester |
| | | | | | film K | film L |
| Thickness of film (μm) | | 51 | 51 | 58 | 39 | 55 |
| Glossiness | | 2.7 | 2.6 | 2.5 | 2.9 | 3.5 |
| JIS1994 | Ra (μm) | 1.276 | 1.336 | 1.421 | 1.507 | 1.330 |
| Line | Ry (μm) | 19.635 | 19.878 | 20.011 | 24.930 | 22.303 |
| roughness | Rz (μm) | 16.589 | 16.758 | 17.574 | 19.225 | 17.496 |
| | S (mm) | 1.974 | 1.981 | 1.956 | 1.922 | 1.834 |
| Film state | Dimension | 40.0 × 10.0 | 40.0 × 10.0 | 40.0 × 10.0 | 40.0 × 10.0 | 40.0 × 10.0 |
| before | (length mm × width mm) | | | | | |
| heating | Thickness (μm) | 51 | 51 | 58 | 39 | 55 |
| test | | | | | | |
| Film state | Dimension | 40.0 × 10.0 | 39.6 × 9.9 | 39.6 × 9.6 | 37.8 × 9.0 | 33.0 × 8.7 |
| after | (length mm × width mm) | | | | | |
| heating | Thickness (μm) | 51 | 52 | 58 | 47 | 76 |
| test | | | | | | |

In Table 1, CARBON FEATHER X1B (product of KIMOTO CO., LTD., Tg of 110° C.) was used as a polyester film K in Comparative Example 1. In Comparative Example 2, SOMABLACK FILM SOMAB-H50MDED (product of SOMAR, Tg of 110° C.) was used as a polyester film L.

### “Result”

The results in Examples 1 to 3 show that the difference in glossiness among the light-shielding films is attributed to the difference in line roughness of the light-shielding films. That is, the line roughness of the light-shielding film has an influence on the transfer member used when the light-shielding film was used, specifically, the frosted glass, the matte PET film, or the matte polyfilm. The results also show that if the glossiness of the light-shielding film is reduced, it is preferable that the line roughness Ra, Ry, and Rz of the light-shielding films are large and S is small. According to Examples 4 and 5, the heated films G and H prepared by subjecting the films C and D to the heating treatment were used. The results show that the dimensional change of the films G and H which had been subjected to the heating treatment once before the heating test was smaller than that of the films C and D which had not been heated. That is, the heated films were more excellent in dimensional change.

### “Evaluation of Film Containing No Black Particles”

### Reference Examples 1 to 3

The shape retentivity of the light-shielding film is influenced by the characteristics of the organic resin contained in the light-shielding film. The shape retentivity of films prepared using organic resins containing no black fine particles was evaluated.

### Reference Example 1

The polymer B 21.30 parts prepared in Synthesis Example 2 was dissolved in cyclohexanone 73.37 parts. The solution was applied on a matte PET film having a thickness of 100 μm, produced by Teijin Dupont Film Japan Ltd. Thus, a colorless transparent film α having a thickness of 52 μm was obtained by a solvent-casting method. The film α (40.0 mm in length×10.0 mm in width×52 μm in thickness) was subjected to a heating test. The film α was measured for dimensional change. The dimensions of the film α before the heating test were 40.0 mm in length×10.0 mm in width×52 μm in thickness. The dimensions of the film α after the heating test were 39.6 mm in length×9.9 mm in width×53 μm in thickness.

### Reference Example 2

The polymer B containing no black fine particles was applied on five PEN films as a specimen (Teonex Q83, product of Teijin Dupont Film Japan Ltd.) in 40.0 mm in length×10.0 mm in width. The obtained films were measured for dimensional change between before and after the heating test. Table 2 shows the results.

### Reference Example 3

A polyimide film (Neoprim L-3430, product of MITSUBISHI GAS CHEMICAL COMPANY, INC., Tg of 300° C.) was subjected to a heating test. The dimensional change of the polyimide film was measured. The dimensions of the polyimide film before the heating test were 40.0 mm in length×10.0 mm in width×57 μm in thickness. The dimensions of the polyimide film after the heating test were 40.0 mm in length×10.0 mm in width×57 μm in thickness.

TABLE 2

| | | Reference Example 2 | | | | |
|---|---|---|---|---|---|---|
| | | PEN Film | | | | |
| Kind of film | | 1 | 2 | 3 | 4 | 5 |
| Film state | Dimension | 40.0 × 10.0 | 40.0 × 10.0 | 40.0 × 10.0 | 40.0 × 10.0 | 40.0 × 10.0 |
| before | (length mm × width mm) | | | | | |
| heating | Thickness (μm) | 75 | 75 | 76 | 74 | 76 |
| test | | | | | | |
| Film state | Dimension | 39.4 × 9.5 | 39.5 × 9.5 | 39.5 × 9.5 | 39.5 × 9.5 | 39.5 × 9.5 |
| after | (length mm × width mm) | | | | | |
| heating | Thickness (μm) | 79 | 79 | 80 | 78 | 80 |
| test | | | | | | |
| Curl | | not curled | not curled | not curled | not curled | not curled |

### “Black Fine Particle-Containing Polymer A Solution: Preparation of Solution S-C”

In a reactor equipped with a thermometer, a cooling tube, a gas inlet tube, and a stirrer, the above-mentioned polymer A 19.5 parts obtained in Synthesis Example 1 was dissolved in methyl isobutyl ketone (4-methyl-2-pentanone) 130.5 parts. Thereinto, carbon black HS-100 (product of DENKI KAGAKU KOGYO K.K.) 4.88 parts was added. Under stirring at a rotation of 700 rpm, 2.0 mm φ zirconia beads 600 parts were added into the mixture. The mixture was heated to 70° C. under stirring at a rotation of 700 rpm. While this temperature was maintained, the stirring was performed for 3 hours. The carbon black was dispersed, and then the obtained solution had a solid content of 15.4% by weight. The obtained methyl isobutyl ketone solution containing the carbon black and the polymer A was further condensed. As a result, a solution S-C having a sold content of 32% by weight was prepared.

### “Black Fine Particle-Containing Polymer A Solution: Preparation of Solution S-D”

A methyl ethyl ketone solution containing the carbon black and the polymer A (solution S-D: solid content of 32% by weight) was prepared in the same manner as in the solution S-C, except that methyl ethyl ketone (2-butanone) was used in stead of the methyl isobutyl ketone.

### Example 9

### Preparation of Film Using Matte PET Film

A film M was obtained by the following solvent-casting method. The above-mentioned solution S-C was applied on a matte PET film as a base material, produced by Teijin Dupont Films Japan Ltd., (name: PSG, thickness of 100 μm). That is, the above-mentioned solution S-C was applied on a matte surface of the base material and heated at 110° C. for 12 minutes. The formed film was separated from the base material. The separated film was further heated at 170° C. for 15 hour. As a result, a film M having a thickness of 52 μm was obtained. The content of the solvent in the film M was 1% or less. Further, the film M was measured for glossiness and surface line roughness on a roughness-transferred surface (on the surface in contact with the base material), and subjected to the following heating test. Table 3 shows the results.

### “Heating Test”

A specimen was prepared by cutting each of the produced films into the following size.

| | |
|---|---|
| Specimen | Film in 40.0 mm × 10.0 mm |
| Test conditions | at 260° C. for 2 minutes (the sample was |
| | put in a hot air dryer at 260° C. and taken |
| | out 2 minutes later). |

The above-mentioned specimen was subjected to the heating test as a sample under the above-mentioned conditions. Then, the sample was measured for dimensional change between before and after the test.

### Example 10

In Example 9, a film N having a thickness of 49 μm was obtained by a solvent-casting method under the same conditions as in Example 9, except that matte film Z TRACETER Z-400.S, produced by SOMER (thickness of 100 μm), was used as a matte PET film. The drying and heating conditions in the solvent-casting method were the same as those in Example 9. The content of the solvent in the film N was 1% or less. The film N was evaluated in the same manner as in Example 9. Table 3 shows the results.

### Example 11

A film O having a thickness of 50 μm was obtained by a solvent-casting method under the same conditions as in Example 9, except that the solution S-D was used in stead of the solution S-C and matte film Z TRACETER Z-400.S, produced by SOMER (thickness of 100 μm), was used as a matte PET film. The content of the solvent in the film O was 1% or less. The film O was evaluated in the same manner as in Example 9. Table 3 shows the results.

### Example 12

The film O obtained in Example 11 was sandwiched between frosted glass plates and then put on a heater and heated at 260° C. for 3 minutes. The heated film O which was taken out of the heater after completion of the heating was defined as a film P that was a heat-treated film. The film P was evaluated in the same manner as in Example 9. Table 3 shows the results.

TABLE 3

| | | | Example | Example | Example | Example |
|---|---|---|---|---|---|---|
| | | Example 9 | 10 | 11 | 12 | 15 |
| Kind of film | | Film M | Film N | Film O | Film P | Film S |
| Thickness of film (μm) | | 52 | 49 | 50 | 51 | 53 |
| Glossiness on the surface | | 2.7 | 1.9 | 1.8 | 1.8 | 3.6 |
| in contact with base material | | | | | | |
| JIS1994 | Ra (μm) | 1.318 | 1.994 | 2.011 | 2.002 | — |
| Line | Ry (μm) | 19.209 | 29.513 | 29.811 | 29.763 | — |
| roughness | Rz (μm) | 15.791 | 23.099 | 23.121 | 23.146 | — |
| | S (mm) | 1.946 | 1.885 | 1.874 | 1.896 | — |
| Film state | Dimension | 40.0 × 10.0 | 40.0 × 10.0 | 40.0 × 10.0 | 40.0 × 10.0 | 40.0 × 10.0 |
| before | (length mm × width mm) | | | | | |
| heating | Thickness (μm) | 52 | 49 | 50 | 51 | 53 |
| test | | | | | | |
| Film state | Dimension | 39.8 × 10.0 | 39.8 × 10.0 | 39.8 × 10.0 | 40.0 × 10.0 | 40.0 × 10.0 |
| after | (length mm × width mm) | | | | | |
| heating | Thickness (μm) | 53 | 50 | 51 | 51 | 53 |
| test | | | | | | |

### Example 13

### Preparation of Film Q Using PET Film (Non-Matte Film)

The solution S-C was applied on a PET film as a base material, produced by Teijin Dupont Film Japan Ltd., (Teijin Tetron Film, type: GE, thickness of 100 μm), and then heated at 110° C. for 12 minutes. Then, the formed film was separated from the base material. As a result, a film Q having a thickness of 52 μm was obtained. The coating was performed in the following manner.

Used apparatus: product of Hohsen Corp., table coater HSCA-15
Coating thickness: The solution was applied using a 400 μm-thickness gauge to have a temporary coating thickness (wet thickness) of 400 μm. Then, the coating thickness was reduced by 50 μm using a provided micrometer.

The content of the solvent in the obtained film Q was 7.9%. The obtained film Q was evaluated for glossiness on the film surface. The glossiness on the surface in contact with the base material was 90 and the glossiness on the surface not in contact with the base material was 39.

### “Preparation of Surface Roughness-Formed Film Using Matte Roll”

The film Q that was a raw material film was provided with roughness using a matte roll. As a result, surface roughness-formed films Q-M1 to Q-M3 were obtained.

The surface roughness was formed using the following device and under the following conditions. The film Q surface not in contact with the base material was subjected to a treatment using a matte roll 1. The thus-obtained film was defined as a film Q-M1. The film Q surface not in contact with the base material was subjected to a treatment using a matte roll 2. The thus-obtained film was defined as a film Q-M2. The film Q surface in contact with the base material was subjected to a treatment using a matte roll 2. The thus-obtained film was defined as a film Q-M3. Each film was subjected to the matte roll treatment at a matte roll temperature of 175° C. Evaluation results of the obtained films Q-M1 to Q-M3 are shown in Table 4. In Table 4, the glossiness before the matte roll treatment shows a glossiness of the film surface for which the matte roll treatment is to be provided. The glossiness, the appearance, and the surface line roughness of the film which had been subjected to the matte roll treatment are those of the film surface for which the matte roll treatment was provided.

Machine: product of YURI ROLL MACHINE CO., LTD., electric heating type emboss machine HEM
Matte roll 1: D5 (sandblasting) Ra=4.2 μm, Rz=25.9 μm
Matte roll 2: B20 (oblique line)
Pattern depth 20 μm 250 lines/1 inch
Matte roll temperature: 175° C. or 200° C.
Compressive load: 5 ton
Film rolling speed: 2 m/min

### Example 14

### Preparation of Film R Using PET Film (Non-Matte Film)

The solution S-C was applied on a PET film as a base material, produced by Teijin Dupont Film Japan Ltd., (Teijin Tetron Film, type: GE, thickness of 100 μm), and heated at 130° C. for 12 minutes and at 150° C. for 4 minutes. As a result, a film R having a thickness of 52 μm was prepared. The content of the solvent in the film R was 5.3%. The glossiness on the surfaces of the film R was evaluated. As a result, the glossiness on the surface not in contact with the base material was 35.

### “Preparation of Surface Roughness-Formed Film Using Matte Roll)”

The surface of the film R that was a raw material film was provided with roughness using a matte roll. As a result, surface roughness-formed films R-M1 and R-M2 were obtained.

The surface roughness was formed using the same device and under the same conditions as those in Example 14. The film R surface not in contact with the base material was subjected to a treatment using a matte roll 2 at a matte roll temperature of 175° C. The thus-obtained film was defined as a film R-M1. The film R surface not in contact with the base material was subjected to a treatment using a matte roll 2 at a matte roll temperature of 200° C. The thus-obtained film was defined as a film R-M2. Table 4 shows the evaluation results of the obtained films R-M1 and R-M2. In Table 4, the glossiness before the matte roll treatment shows a glossiness of the film surface for which the matte roll treatment is to be provided. The glossiness, the appearance, and the surface line roughness of the obtained film are those of the film surface for which the matte roll treatment was provided.

TABLE 4

| | | | Example 13 | | | Example 14 | |
|---|---|---|---|---|---|---|---|
| Matte property-providing test | | | 1 | 2 | 3 | 4 | 5 |
| Used film | | | Film Q | Film Q | Film Q | Film R | Film R |
| Content of solvent | | | 7.8 | 7.8 | 7.8 | 5.3 | 5.3 |
| remaining in film (%) | | | | | | | |
| Used roll | | | Matte roll 1 | Matte roll 2 | Matte roll 2 | Matte roll 2 | Matte roll 2 |
| Temperature (° C.) | | | 175 | 175 | 175 | 175 | 200 |
| The number of times | | | 1 | 1 | 1 | 1 | 1 |
| of matte treatment | | | | | | | |
| Before | Surface in contact | | Glossiness | Glossiness | Glossiness | Glossiness | Glossiness |
| test | with matte roll | | 39 | 40 | 90 | 35 | 35 |
| | JIS1994 | Ra (μm) | 0.794 | — | — | — | — |
| | Line | Ry (μm) | 10.627 | — | — | — | — |
| | roughness | Rz (μm) | 8.873 | — | — | — | — |
| | | S (mm) | 2.068 | — | — | — | — |
| Obtained film | | | Q-M1 | Q-M2 | Q-M3 | R-M1 | R-M2 |
| After | Glossiness | | 9.9 | 3.2 | 7.6 | 3.3 | 3.1 |
| test | (surface in contact | | | | | | |
| | with matte roll) | | | | | | |
| | Film appearance | | Much foam | Much foam | Much foam | Almost | Almost |
| | | | | | | no foam | no foam |
| | JIS1994 | Ra (μm) | 1.177 | — | — | — | — |
| | Line | Ry (μm) | 16.975 | — | — | — | — |
| | roughness | Rz (μm) | 10.834 | — | — | — | — |
| | | S (mm) | 1.798 | — | — | — | — |

### Example 15

### Heating Test after Matte Property-Providing Test

The film R-M1 obtained in Example 14 was further dried at 170° C. for 15 hours. The film after drying was sandwiched between frosted glass plates, and then heated on a heater at 260° C. for 3 minutes. As a result, a film S having a thickness of 53 μm was obtained. In the obtained film S, the surface for which the matte roll treatment had been provided had a glossiness of 3.6. After the following heating test, the dimensions of the film were 40.0 mm in length×10.0 in width×53 μm in thickness. The dimensions of the film before the heating test were 40.0 mm in length×10.0 mm in width×53 μm in thickness. Thus, no dimensional change was observed.

### Examples 16 to 28

### Preparation of Applying Liquid by Dispersing Carbon Black into Polyamic Acid Solution

Polyimide varnish U-varnish A produced by UBE INDUSTRIES, LTD., polyimide varnish Pyre-ML RC 5057, RC 5097, produced by I.S.T Corp., as a polyimide resin raw material; polymer graft carbon black (EPOTONE LY, produced by NIPPON SHOKUBAI Co., Ltd.) as a black material; and BYK-306, BYK-322, BYK-330, BYK-331, BYK-333, and BYK-375 produced by BYK CHEMIE Japan INC., as a surface conditioner, were mixed at a proportion (part by weight) shown in Table 5 and filtrated through a SUS 300 mesh. The filtrate was defoamed under vacuum for 1 hour at a normal temperature. As a result, coating dispersions that were light-shielding resin compositions were obtained. The mixing conditions are shown below.

Mixer: Awatori Rentaro AR-250, product of THINKY Co., Ltd.
Mixing conditions: 10 minutes for stirring, 5 minutes for defoaming

### “Preparation of Film”

Films were prepared using the respective coating dispersions. The respective coating dispersions were applied on a matte PET film produced by Teijin Dupont Film Japan Ltd., (name: PSG, thickness of 100 μm) and then dried and baked. As a result, films T to Z and AA to AD were obtained. In Example 27, a film AE was obtained by applying the coating dispersion on a PET film produced by Teijin Dupont Film Japan Ltd., (Teijin Tetron Film, type: GE, thickness of 100 μm, smooth surface) and then drying and baking it.

In Example 28, a film AF was obtained by applying the coating dispersion on a PET film produced by Teijin Dupont Film Japan Ltd., (Teijin Tetron Film, Type: GE, thickness of 100 μm), and then drying it (without baking it). The conditions for the coating, drying and baking are shown below.

### “Coating Conditions”

Used apparatus: product of Hohsen Corp., table coater HSCA-15
Coating thickness: The solution was applied using a 400 μm-thickness gauge to have a temporary coating thickness of 400 μm. Then, the coating thickness was reduced using a provided micrometer in such a way that the thickness of the film after being kept in a drying oven at 140° C. for 90 seconds is 55 μm.
Drying temperature in drying oven: 140° C.
Drying time in drying oven: 90 seconds
Drying conditions: The solution was dried at 120° C. for 40 minutes, and separated from the base material. Then, the separated film was heated at 150° C. for 10 minutes and at 200° C. for 10 minutes.
Baking conditions: 280° C. for 30 minutes

The thickness, glossiness, appearance of the obtained film, and the results of the heating test are shown in Table 5.

TABLE 5

| | | Example | Example | Example | Example | Example | Example | Example |
|---|---|---|---|---|---|---|---|---|
| | | 16 | 17 | 18 | 19 | 20 | 21 | 22 |
| U-varnish A | | 91.30 | 91.30 | 91.30 | 91.30 | 91.30 | 91.30 | 91.30 |
| RC5057 | | — | — | — | — | — | — | — |
| RC5097 | | — | — | — | — | — | — | — |
| EPOTONE LY | | 8.70 | 8.70 | 8.70 | 8.70 | 8.70 | 8.70 | 8.70 |
| BYK-306 | | — | 0.20 | — | — | — | — | — |
| BYK-322 | | — | — | 0.20 | — | — | — | — |
| BYK-330 | | — | — | — | 0.20 | — | — | — |
| BYK-331 | | — | — | — | — | 0.20 | — | — |
| BYK-333 | | — | — | — | — | — | 0.20 | — |
| BYK-375 | | — | — | — | — | — | — | 0.20 |
| Base material film used | | PSG | PSG | PSG | PSG | PSG | PSG | PSG |
| for coating | | | | | | | | |
| Obtained film | | Film T | Film U | Film V | Film W | Film X | Film Y | Film Z |
| Film thickness (μm) | | 45 | 45 | 46 | 44 | 45 | 46 | 45 |
| Glossiness on surface in | | 2.3 | 2.3 | 2.4 | 2.3 | 2.5 | 2.4 | 2.4 |
| contact with base material | | | | | | | | |
| Appearance of surface not | | Glossy | Glossy | Orange | Orange | Glossy | Glossy | Glossy |
| in contact with base | | excellent | excellent | peel-like | peel-like | excellent | excellent | excellent |
| material | | | | surface | surface | | | |
| Film appearance | | Many | No | No | No | Many | Some | Some |
| | | voids | voids | voids | voids | voids | voids | voids |
| Film state | Dimension | 40.0 × 10.0 | 40.0 × 10.0 | 40.0 × 10.0 | 40.0 × 10.0 | 40.0 × 10.0 | 40.0 × 10.0 | 40.0 × 10.0 |
| before | (length mm × | | | | | | | |
| heating | width mm) | | | | | | | |
| test | Thickness (μm) | 45 | 45 | 46 | 44 | 45 | 46 | 45 |
| Film state | Dimension | 40.0 × 10.0 | 40.0 × 10.0 | 40.0 × 10.0 | 40.0 × 10.0 | 40.0 × 10.0 | 40.0 × 10.0 | 40.0 × 10.0 |
| after | (length mm × | | | | | | | |
| heating | width mm) | | | | | | | |
| test | Thickness (μm) | 45 | 45 | 46 | 44 | 45 | 46 | 45 |

| | | Example | Example | Example | Example | Example | Example |
|---|---|---|---|---|---|---|---|
| | | 23 | 24 | 25 | 26 | 27 | 28 |
| U-varnish A | | — | — | — | — | 91.30 | 91.30 |
| RC5057 | | 92.02 | 92.02 | — | — | — | — |
| RC5097 | | — | — | 94.39 | 94.39 | — | — |
| EPOTONE LY | | 7.98 | 7.98 | 5.61 | 5.61 | 8.70 | 8.70 |
| BYK-306 | | — | 0.20 | — | 0.20 | 0.20 | 0.20 |
| BYK-322 | | — | — | — | — | — | — |
| BYK-330 | | — | — | — | — | — | — |
| BYK-331 | | — | — | — | — | — | — |
| BYK-333 | | — | — | — | — | — | — |
| BYK-375 | | — | — | — | — | — | — |
| Base material film used | | PSG | PSG | PSG | PSG | GE | GE |
| for coating | | | | | | | |
| Obtained film | | Film | Film | Film | Film | Film | Film |
| | | AA | AB | AC | AD | AE | AF |
| Film thickness (μm) | | 45 | 45 | 44 | 46 | 45 | 43 |
| Glossiness on surface in | | 2.5 | 2.3 | 2.3 | 2.4 | 90 | 88 |
| contact with base material | | | | | | | |
| Appearance of surface not | | Glossy | Glossy | Glossy | Glossy | Glossy | Glossy |
| in contact with base | | excellent | excellent | excellent | excellent | excellent | excellent |
| material | | | | | | | |
| Film appearance | | Many | No | Many | No | No | No |
| | | voids | voids | voids | voids | voids | voids |
| Film state | Dimension | 40.0 × 10.0 | 40.0 × 10.0 | 40.0 × 10.0 | 40.0 × 10.0 | 40.0 × 10.0 | — |
| before | (length mm × | | | | | | |
| heating | width mm) | | | | | | |
| test | Thickness (μm) | 45 | 45 | 44 | 46 | 45 | — |
| Film state | Dimension | 40.0 × 10.0 | 40.0 × 10.0 | 40.0 × 10.0 | 40.0 × 10.0 | 40.0 × 10.0 | — |
| after | (length mm × | | | | | | |
| heating | width mm) | | | | | | |
| test | Thickness (μm) | 45 | 45 | 44 | 46 | 45 | — |

### Example 29

The film AE obtained in Example 27 was further subjected to a sandblasting treatment, thereby being provided with a matte property.

Machine: product of ELfotec Ltd., ELP-1TR

### Abrasive: Alumina (WA), Carbon (GC)

When the film AE was prepared, the film surface not in contact with the base material was subjected to the sandblasting treatment under the conditions shown in Table 6. The evaluation results of the obtained films AE-S1 to AE-S5 are shown in Table 6. The glossiness shown in Table 6 is a glossiness of the surface for which the sandblasting treatment was performed.

TABLE 6

| | | | The number of | | |
|---|---|---|---|---|---|
| | | Air | times of | | |
| | | pressure | sandblasting | Glossiness | |
| Film | Abrasive | (MPa) | treatment | of film | Film appearance |
| AE-S1 | GC-600 | 0.05 | 1 | 3.7 | Wrinkles of various sizes, |
| | | | | | twist, and void are observed |
| AE-S2 | GC-600 | 0.05 | 3 | 0.9 | Wrinkles of various sizes, |
| | | | | | twist, and void are observed |
| AE-S3 | WA-600 | 0.05 | 2 | 1.0 | Wrinkles of various sizes, |
| | | | | | twist, and void are observed |
| AE-S4 | WA-320 | 0.05 | 1 | 0.4 | Wrinkles of various sizes, |
| | | | | | twist, and void are observed |
| AE-S5 | WA-1200 | 0.05, 0.01 | One each | 32 | Wrinkles of various sizes |
| | | | | | and twist are observed |

### Example 30

The film AE obtained in Example 27 was subjected to a matte roll treatment. The film AE surface not in contact with the base material was subjected to a treatment once using a matte roll 2 at a matte roll temperature of 175° C. The thus-obtained film was defined as a film AE-M1. The film AE surface not in contact with the base material was subjected to a treatment once using the matte roll 2 at a matte roll temperature of 200° C. The thus-obtained film was defined as a film AE-M2. The film AE surface not in contact with the base material was subjected to a treatment twice using the matte roll 2 at a matte roll temperature of 175° C. The thus-obtained film was defined as a film AE-M3. Each of the film AE surface not in contact with the base material and that in contact with the base material was subjected to a treatment once with the matte roll 2 at a matte roll temperature of 175° C. The thus-obtained film was defined as a film AE-M4.

The glossiness and appearance of the obtained films AE-M1 to AE-M4 are shown in Table 7.

After the heating test, the dimensions of the film AE-M2 were 40.0 mm in length×10.0 mm in width×45 μm in thickness. The dimensions of the film before the heating test were 40.0 mm in length×10.0 mm in width×45 μm in thickness. No dimensional change was observed.

### Example 31

The surface not in contact with the base material of the film U obtained in Example 17 was subjected to a treatment once using the matte roll 2 at a matte roll surface of 175° C. As a result, a film U-M1 was obtained. The glossiness and appearance of the obtained film U-M1 are shown in Table 7.

### Example 32

The surface not in contact with the base material of the film AF obtained in Example 28 was subjected to a treatment once with the matte roll 2 at a matte roll temperature of 200° C. and then subjected to a baking treatment at 280° C. for 30 minutes. As a result, a film AF-M1 was obtained. The glossiness and appearance of the obtained film AF-M1 are shown in Table 7. After the heating test, the dimensions of the film AF-M1 were 40.0 mm in length×10.0 mm in width×45 μm in thickness. The dimensions of the film before the heating test were 40.0 mm in length×10.0 mm in width×45 μm in thickness. Thus, no dimensional change was observed.

The films obtained in each Example (films C to J, M to Z, Q-M1 to Q-M3, R-M1, R-M2, AA to AF, AE-S1 to AE-S5, AE-M1 to AE-M4) were measured for a spectral transmittance using a spectrophotometer (product of Shimadzu Corporation., Shimadzu self-recording spectrophotometer UV-3100). As a result, each film showed 0.1% or less of a transmittance for light at a wavelength of 300 to 800 nm. Even the films which had been subjected to the heating test were similarly measured for a transmittance. As a result, each film showed 0.1% or less of a transmittance for light at a wavelength of 300 to 800 nm.

TABLE 7

| | | | | | | Example | Example |
|---|---|---|---|---|---|---|---|
| | | Example 30 | | | | 31 | 32 |
| Matte property-providing | | 6 | 7 | 8 | 9 | 10 | 11 |
| test | | | | | | | |
| Used film | | Film AE | Film AE | Film AE | Film AE | Film U | Film AF |
| Used roll | | Matte roll 2 | Matte roll 2 | Matte roll 2 | Matte roll 2 | Matte roll 2 | Matte roll 2 |
| Temperature (° C.) | | 175 | 200 | 175 | 175 | 175 | 200 |
| The number of times of | | 1 | 1 | 2 | Once for | 1 | 1 |
| matte treatment | | | | | each | | |
| | | | | | surface | | |
| Obtained film | | AE-M1 | AE-M2 | AE-M3 | AE-M4 | U-M1 | AF-M1 |
| Before | Glossiness | 43 | 43 | 43 | 44 | 45 | 45 |
| test | (surface in contact | | | | | | |
| | with matte roll) | | | | | | |
| After | Glossiness | 21 | 15 | 7.2 | 18 | 23 | 5.7 |
| test | (surface in contact | (the other | | | (the other | | |
| | with matte roll) | surface 48) | | | surface 21) | | |
| | Film appearance | No foam | No foam | No foam | No foam | No foam | No foam |

### Example 33

### Preparation of Coating Dispersion

Polyimide varnish U-varnish A produced by UBE INDUSTRIES 85.32 parts, EPOTONE LY produced by NIPPON SHOKUBAI Co., Ltd. 14. 69 parts, and BYK-306 produced by BYK CHEMIE Japan INC. 0.2 parts were mixed under the following conditions using the following equipment. Then, the mixture was filtrated through a SUS 300 mesh. The filtrate was defoamed under vacuum for 1 hour at a normal temperature. As a result, a carbon black-containing polyamic acid solution was obtained, and this was used as a coating dispersion (composition for forming a light-shielding layer).

Mixer: Awatori Rentaro AR-250, product of THINKY Co., Ltd.
Mixing conditions: 10 minutes for stirring, 5 minutes for defoaming

### “Preparation of Light-Shielding Film”

### Formation of Three-Layer Film

In the following manner, the above-obtained coating dispersion was applied on both surfaces of a Kapton film produced by Toray-Dupont Co., Ltd., (V type, thickness of 25 μm) as a base material. As a result, a light-shielding layer having a light-shielding layer on each surfaces was formed.

A table coater HSCA-15, produced by Hohsen Corp., was used a coater.

### “Coating Conditions”

The solution was applied using a 400 μm-thickness gauge to have a temporary coating thickness (wet thickness) of 400 μm. Then, the coating thickness was reduced from 400 μm using a provided micrometer of the table coater in such a way that the thickness of the film after being kept in a drying oven at 130° C. for 2 minutes and 30 seconds is 20 μm. A semi-dried film 1 having a thickness of 20 μm, formed of the light-shielding resin composition, was formed on one surface of the base material.

Then, on the other surface (on the surface where no solution was applied) of the obtained film, a semi-dried film 2 having a thickness of 20 μm, formed of the light-shielding resin composition, was formed in the above-mentioned manner. As a result, a three-layer film AG including a semi-dried film having a thickness of 20 μm on the each surface of the base material (Kapton film) was obtained. The films 1 and 2 of the film AG were measured for an amount of the residual solvent. The amount of the residual solvent in the film 1 (which was subjected to the drying twice at 130° C. for 2 minutes and 30 seconds) was 31% by weight. The amount of the residual solvent in the film 2 (which was subjected to the drying once at 130° C. for 2 minutes and 30 seconds) was 35% by weight. In addition, the film AG was measured for glossiness. The film 1 surface had a glossiness of 100. The film 2 surface had a glossiness of 97.

### “Formation of Surface Roughness and Baking”

The both surfaces (the semi-dried films 1 and 2) of the film AG were provided with roughness using a matte roll. Thereby, the film AG-M1 was prepared and further, subjected to drying at 130° C. for 10 minutes and 200° C. for 10 minutes, and finally baked at 280° C. for 30 minutes. As a result, a light-shielding film AG-M1H having a rough light-shielding layers (light-shielding layers 1 and 2) on the each surface was obtained.

The surface roughness was formed using the following equipment and under the following conditions.

### “Matte Treatment Conditions”

Machine: product of YURI ROLL MACHINE CO., LTD., electric heating type emboss machine HEM
Used roll: Matte roll 2 (B20 (oblique line) Pattern depth 20 μm, 250 lines/1 inch)
Compressive load: 5 ton
Film rolling speed: 2 m/min
Matte roll temperature: 120° C.
The number of times of matte roll treatment: once for each surface

### “Evaluation Results of Light-Shielding Film”

The film whose surfaces had been provided with roughness and the film which had been baked were evaluated for glossiness and appearance. The results were shown below.

### “Evaluation Results of Film AG-M1”

Glossiness on the film 1 surface: 6.3
Glossiness on the film 2 surface: 5.9
Appearance of film: No foam was observed in both of the film 1 and the film 2.

### “Evaluation Results of Film AG-M1H”

Glossiness on the light-shielding layer 1 surface: 8.4
Glossiness on the light-shielding layer 2 surface: 8.2
Appearance of the film: No foam was observed in both of the film 1 and the film 2.

The film AG-M1H was subjected to the heating test in the same manner as in Example 1. The dimensions of the film AG-M1H before the heating test were 40.0 mm in length×10.0 mm in width×51 μm in thickness. The dimensions of the film AG-M1H after the heating test were 40.0 mm in length×10.0 mm in width×51 μm in thickness. Thus, no dimensional change was observed.

1. A light-shielding film comprising a light-shielding layer including an organic resin and a black material,
the light-shielding film being a film consisting of the light-shielding layer or a multilayer film including a base material and the light-shielding layer,
wherein a material for the base material includes at least one selected from the group consisting of (1) a fluorinated aromatic polymer, (2) a polycyclic aromatic polymer, (3) a polyimide resin, (4) a fluorine-containing polymer compound, (5) a glass film, and (6) a polyether ketone resin,
wherein the organic resin is a cured product of a curable resin or a thermoplastic resin having a glass transition temperature of 150° C. or more.

2. The light-shielding film according to claim 1, wherein the organic resin is at least one selected from the group consisting of a polyimide resin, an epoxy resin, a fluorinated aromatic polymer, a polyether ketone resin, and a polyethylene naphthalate resin.

3. The light-shielding film according to claim 1,
wherein at least one surface of the light-shielding film has a glossiness of 20 or less.

4. The light-shielding film according to claim 1, wherein the organic resin is obtainable using a solvent-soluble organic resin raw material.

5. The light-shielding film according to claim 1,
wherein the solvent-soluble organic resin raw material is a polyamic acid or an epoxy compound.

6. The light-shielding film according to claim 1, wherein at least one surface of the light-shielding film has a rough structure.

7. The light-shielding film according claim 2, wherein at least one surface of the light-shielding film has a rough structure.

8. The light-shielding film according to claim 1, wherein a surface of the light-shielding film has an arithmetical mean deviation Ra of 0.3 μm or more.

9. The light-shielding film according to claim 1, wherein the light-shielding film shows 10% or less of a dimensional change in each of length, width, and thickness between before and after heating at 260° C. for 2 minutes under air atmosphere.

10. The light-shielding film according to claim 1, wherein the light-shielding film is used in a lens unit that can be subjected to a soldering reflow process.

11. A production method of a light-shielding film according to claim 1,
wherein at least one surface of the light-shielding film has a rough structure, the production method comprises a surface roughness-forming step of forming the rough surface of the light-shielding film by a transfer method.

12. A production method of a light-shielding film according to claim 2,
wherein at least one surface of the light-shielding film has a rough structure, wherein the production method comprises a surface roughness-forming step of forming the rough surface of the light-shielding film by a transfer method.

13. The production method of the light-shielding film according to claim 11,
wherein the production method comprises a coating step of applying a light-shielding resin composition, and
the surface roughness-forming step is performed simultaneously with and/or successively after the coating step.

14. The production method of the light-shielding film according to claim 11,
wherein in the surface roughness-forming step, one rough surface of the light-shielding film and the other rough surface of the light-shielding film are simultaneously and/or successively formed.

15. The production method of the light-shielding film according to claim 11,
wherein the surface roughness-forming step includes a step of forming a coating film made of the light-shielding resin composition on a transfer layer.

16. The production method of the light-shielding film according to claim 11,
wherein the surface roughness-forming step includes a step of bringing a film made of the light-shielding resin composition into contact with the transfer layer.

17. The production method of the light-shielding film according to claim 11,
wherein the surface roughness-forming step includes a step of bringing the light-shielding film into contact with the transfer layer.

18. A lens unit comprising the light-shielding film according to claim 1 and a lens.

19. A lens unit comprising the light-shielding film according to claim 2 and a lens.

20. A lens unit comprising the light-shielding film according to claim 6 and a lens.
